(19) United States
(12) Patent Application Publication
(10) Pub. No.: US 2019/0007969 A1
(43) Pub. Date: Jan. 3, 2019

(54) WIRELESS COMMUNICATION SYSTEM, WIRELESS COMMUNICATION DEVICE, AND COMMUNICATION METHOD

(71) Applicant: FUJITSU LIMITED, Kawasaki-shi (JP)

(72) Inventor: HIDEHARU SHAKO, Yokohama (JP)

(73) Assignee: FUJITSU LIMITED, Kawasaki-shi (JP)

(21) Appl. No.: 16/011,949

(22) Filed: Jun. 19, 2018

(30) Foreign Application Priority Data
Jun. 28, 2017 (JP) 2017-126569

(51) Int. Cl. H04W 74/08; H04L 5/14; H04W 72/04; H04W 24/10

(52) U.S. Cl. CPC H04W 74/0808; H04W 24/10; H04W 72/0446; H04L 5/14

(57) ABSTRACT

A wireless communication system includes a server and a plurality of wireless communication devices representing nodes assigned to the server. The server sends notification information in which the starting position of a frame is specified. Each wireless communication device includes a notification information processing unit that receives notification information; and includes a communication processing unit that performs communication of the Time Division Duplex (TDD) type, and performs communication of the Carrier Sense Multiple Access (CSMA) type during the periods of time between downlink time period and uplink time period of the TDD type.

### CROSS-REFERENCE TO RELATED APPLICATION(S)

This application is based upon and claims the benefit of priority of the prior Japanese Patent Application No. 2017-126569, filed on Jun. 28, 2017, the entire contents of which are incorporated herein by reference.

### FIELD

The embodiments discussed herein are related to a wireless communication system, a wireless communication device, and a wireless method.

### BACKGROUND

In recent years, there has been a considerable rise in the use of the Wi-Fi (Wireless Fidelity, registered trademark) in factories or open offices. When the number of devices connected to the Wi-Fi increases, there are times when the line quality deteriorates due to radio wave interference or hidden terminals.

For example, as a wireless communication system, the present-day Wi-Fi is operated based on a technology called the CSMA technology (CSMA stands for Carrier Sense Multiple Access). In the CSMA technology, each wireless communication device (an access point or a device) performs communication by monitoring the radio waves of other wireless communication devices. Moreover, in the CSMA technology, before starting the wireless communication, the concerned wireless communication device confirms whether or not there is no wireless communication device performing communication (i.e., carrier sense (CS)), and starts communication when there is no wireless communication device performing communication (i.e., multiple access (MA)). Moreover, even after becoming able to perform communication as a result of the carrier sense (CS), the concerned wireless communication device further waits for a random period of time before starting data transmission. However, in the CSMA technology, since control for communication authorization between access points and devices is used along with using standby period, the traffic efficiency deteriorates rapidly if the number of devices increases.

In that regard, in order to resolve the issues arising in the CSMA technology, consider a case of operating the wireless communication system in a technology called TDMA technology (TDMA stands for Time Division Multiple Access). For example, as far as communication of the TDMA type is concerned, the TDMA/TDD technology (TDD stands for Time Division Duplex) is implemented. Hereinafter, the TDMA/TDD technology is written as TDD technology.

In the TDD technology, a single channel is partitioned into time units called slots along the time axis, and the data is sent and received within the periods of time decided in between the slots. For example, as illustrated in FIG. 47, a wireless communication system includes, as wireless communication devices, a gateway (hereinafter, abbreviated as GW), access points (hereinafter, abbreviated as APs), and a station (hereinafter, abbreviated as STA). Herein, downlink data is transferred in the path from the GW to the STA via APs #101 and #102, and uplink data is transferred in the opposite path. Moreover, in the TDD technology, downlink time periods are set in which downlink data is transferred (see “TDMA downlink” in FIG. 48), and uplink time periods are set in which uplink data is transferred (see “TDMA uplink” in FIG. 48). Conventional technique is described in Japanese Laid-open Patent Publication No. 2000-197089 and Japanese National Publication of International Patent Application No. 2011-514740.

However, if the TDD technology is implemented in an environment for multihop communication having a multistage configuration, gap periods are formed as follows.

For example, as illustrated in FIG. 48, during the transfer of downlink data, a delay period Δt101 attributed to the delay in slot units and attributed to the space propagation delay occurs between the GW and the AP #101. In an identical manner, delay periods Δt102 and Δt103 attributed to the delay in slot units and attributed to the space propagation delay occur between the AP #101 and the AP #102 and between the AP #102 and the STA, respectively. During the transfer of uplink data, it is the opposite to the case of downlink data transfer. In this case, at the time of performing downlink data transfer and uplink data transfer between the GW and the STA; for example, after sending data during downlink time slots, the GW waits for a predetermined delay period (gap period) until data is received during uplink time slots.

### SUMMARY

According to an aspect of an embodiment, a wireless communication system includes a server and a plurality of wireless communication devices. The server sends notification information in which starting position of a frame is specified. The plurality of wireless communication devices represent nodes assigned to the server. Each of the plurality of wireless communication devices includes a notification information processing unit and a communication processing unit. The notification information processing unit receives the notification information. The communication processing unit, according to the notification information, performs communication of time division duplex (TDD) type, and performs communication of carrier sense multiple access (CSMA) type during a period of time between a downlink time period and an uplink time period of the TDD type.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining the overview of a wireless communication system according to a first embodiment;

FIG. 2 is a diagram for explaining transmission and reception of data in the wireless communication system according to the first embodiment;

FIG. 3 is a block diagram illustrating an exemplary configuration of the wireless communication system according to the first embodiment;

FIG. 4 is a block diagram illustrating an exemplary configuration of a server of the wireless communication system according to the first embodiment;

FIG. 5 is a block diagram illustrating an exemplary configuration of a gateway (GW) of the wireless communication system according to the first embodiment;

FIG. 6 is a block diagram illustrating an exemplary configuration of an access point (AP) of the wireless communication system according to the first embodiment;

FIG. 7 is a block diagram illustrating an exemplary configuration of a station (STA) of the wireless communication system according to the first embodiment;

FIG. 8 is a block diagram illustrating an exemplary frame configuration in the wireless communication system according to the first embodiment;

FIG. 9 is a block diagram illustrating an exemplary configuration of a transmission-reception timing control unit of the GW, the APs, and the STAs in the wireless communication system according to the first embodiment;

FIG. 10 is a block diagram illustrating an exemplary configuration of the transmission-reception timing control unit of the GW, the APs, and the STAs of the wireless communication system according to a second embodiment;

FIG. 11 is a diagram for explaining the issues arising in the wireless communication system according to the second embodiment;

FIG. 12 is a diagram for explaining an issue (1) arising in the wireless communication system according to the second embodiment;

FIG. 13 is a diagram for explaining an issue (2) arising in the wireless communication system according to the second embodiment;

FIGS. 14 and 15 are diagrams for explaining a solution to the issue (1) arising in the wireless communication system according to the second embodiment;

FIG. 16 is a sequence diagram illustrating an exemplary solution to the issue (1) in the wireless communication system according to the second embodiment;

FIGS. 17 and 18 are diagrams for explaining a solution to the issue (2) in the wireless communication system according to the second embodiment;

FIG. 19 is a sequence diagram illustrating an exemplary solution to the issue (2) in the wireless communication system according to the second embodiment;

FIG. 20 is a diagram for explaining the solutions in the wireless communication system according to the second embodiment;

FIGS. 21 to 23 are diagrams for explaining the issues arising in the wireless communication system according to a third embodiment;

FIG. 24 is a block diagram illustrating an exemplary configuration of the AP of the wireless communication system according to the third embodiment;

FIG. 25 is a diagram for explaining a solution to the issues arising in the wireless communication system according to the third embodiment;

FIG. 26 is a sequence diagram illustrating an exemplary solution to the issues arising in the wireless communication system according to the third embodiment;

FIG. 27 is an image diagram of delay measurement performed in the wireless communication system according to a fourth embodiment;

FIG. 28 is an image diagram of the transfer of a delay measurement packet in the wireless communication system according to the fourth embodiment;

FIG. 29 is a block diagram illustrating an exemplary configuration of the GW in the wireless communication system according to the fourth embodiment;

FIG. 30 is a block diagram illustrating an exemplary configuration of a delay measuring unit of the GW in the wireless communication system according to the fourth embodiment;

FIG. 31 is a diagram for explaining a solution to the issues arising in the wireless communication system according to the fourth embodiment;

FIG. 32 is a sequence diagram illustrating an exemplary solution to the issues arising in the wireless communication system according to the fourth embodiment;

FIGS. 33 to 36 are diagrams for explaining the issues arising in the wireless communication system according to a fifth embodiment;

FIG. 37 is a diagram for explaining a solution 1-1 with respect to the issues arising in the wireless communication system according to the fifth embodiment;

FIG. 38 is a block diagram illustrating an exemplary configuration of the transmission-reception timing control unit of the GW, the APs, and the STAs in the wireless communication system according to the fifth embodiment;

FIG. 39 is a sequence diagram illustrating an exemplary solution 1-1 with respect to the issues arising in the wireless communication system according to the fifth embodiment;

FIG. 40 is a diagram for explaining a solution 1-2 with respect to the issues arising in the wireless communication system according to the fifth embodiment;

FIG. 41 is a sequence diagram illustrating an exemplary solution 1-2 with respect to the issues arising in the wireless communication system according to the fifth embodiment;

FIG. 42 is a sequence diagram illustrating an exemplary solution 2 with respect to the issues arising in the wireless communication system according to the fifth embodiment;

FIG. 43 is a diagram illustrating an exemplary hardware configuration of the server;

FIG. 44 is a diagram illustrating an exemplary hardware configuration of the GW;

FIG. 45 is a diagram illustrating an exemplary hardware configuration of the AP;

FIG. 46 is a diagram illustrating an exemplary hardware configuration of the STA;

FIG. 47 is a diagram for explaining the overview of a conventional wireless communication system; and

FIG. 48 is a diagram for explaining transmission and reception of data in the conventional wireless communication system.

### DESCRIPTION OF EMBODIMENTS

Preferred embodiments of the present invention will be explained with reference to accompanying drawings. However, the technology disclosed herein is not limited by the embodiments described below.

### [a] First Embodiment

Overview

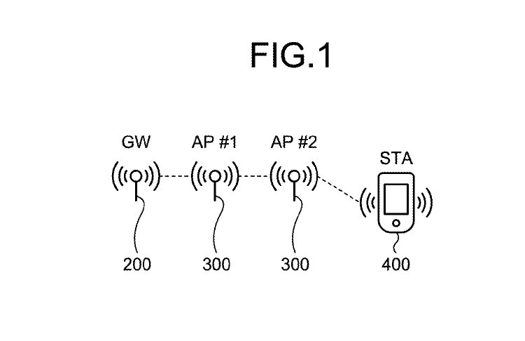

FIG. 1 is a diagram for explaining the overview of a wireless communication system according to a first embodiment. The wireless communication system according to the first embodiment includes a gateway 200 (hereinafter, written as a GW 200), a plurality of access points 300 (hereinafter, written as APs 300), and a plurality of stations (hereinafter, written as STAs 400). Herein, the GW 200, the APs 300, and the STAs 400 represent examples of a “wireless communication device”.

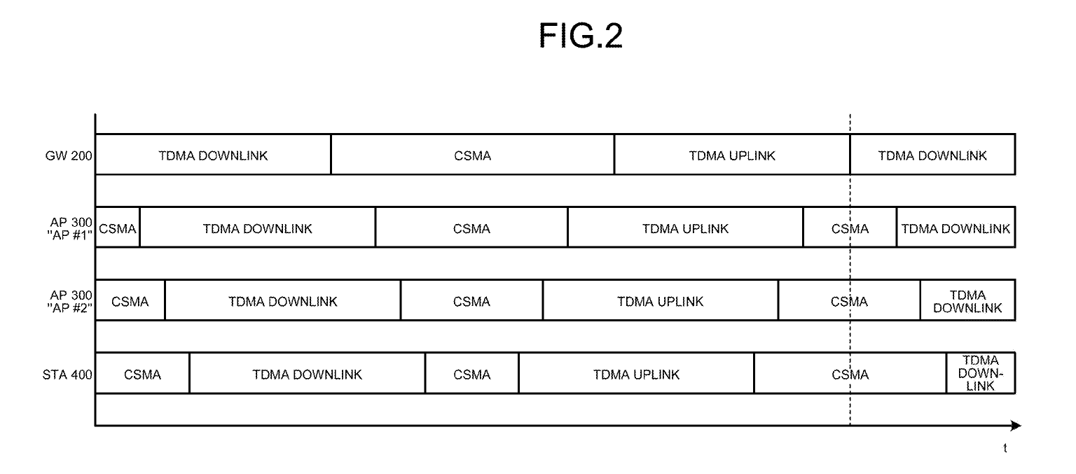

In the TDMA/TDD technology (TDMA stands for Time Division Multiple Access, and TDD stands for Time Division Duplex), a single channel is partitioned into time units called slots along the time axis, and the data is sent and received within the periods of time decided in between the slots. Hereinafter, the TDMA/TDD technology is written as TDD technology. FIG. 2 is a diagram for explaining transmission and reception of data in the wireless communication system according to the first embodiment. For example, downlink data is transferred in the path from the GW 200 to the STA 400 via the two APs 300 (“AP #1” and “AP #2” in FIGS. 1 and 2), and uplink data is transferred in the opposite path.

Moreover, in the TDD technology, downlink time periods are set in which downlink data is transferred (see “TDMA downlink” in FIG. 2) and uplink time periods are set in which uplink data is transferred (see “TDMA uplink” in FIG. 2). However, as described earlier, if the TDMA/TDD technology (hereinafter, written as TDD technology) is implemented in an environment for multihop communication having a multistage configuration, gap periods are formed due to delay periods (the delay in slot units and the space propagation delay) occurring at the time of performing data transfer using multihop communication. That is, in the TDD technology, at the time of performing downlink data transfer and uplink data transfer between the GW 200 and the STA 400; for example, after sending data during downlink time periods, the GW 200 waits for a gap period until data is received during uplink time periods.

Herein, as illustrated in FIG. 2, in the wireless communication system according to the first embodiment, communication of the CSMA type (CSMA stands for Carrier Sense Multiple Access) is assigned during the gap periods. That is, in the wireless communication system according to the first embodiment, time periods of the CSMA type (“CSMA” illustrated in FIG. 2) are sandwiched between downlink time periods of the TDD type (“TDMA downlink” illustrated in FIG. 2) and uplink time periods of the TDD type (“TDMA uplink” illustrated in FIG. 2). The time periods of the CSMA type enable communication with the APs that are directly connected without supporting data hopping, and can be used as control information areas for data retransmission, connection monitoring, and radio wave measurement information.

For example, a server 100 specifies the starting positions of frames. According to the starting positions of the frames; the GW 200, the APs 300, and the STAs 400 perform communication of the TDD type (“TDMA downlink” and “TDMA uplink” illustrated in FIG. 2). Moreover, with respect to the GW 200, the APs 300, and the STAs 400; communication of the CSMA type (“CSMA” illustrated in FIG. 2) is performed in the periods of time (gap periods) between the downlink time periods and the uplink time periods of the TDD type. In the GW 200, the APs 300, and the STAs 400; the gap periods after downlink time periods of the TDD type and the gap periods after uplink time periods of the TDD type are measured and decided in advance. According to the starting positions of the frames as specified from the server 100; the GW 200, the APs 300, and the STAs 400 perform communication of downlink data of the TDD type, perform communication of the CSMA type, and perform communication of uplink data of the TDD type. As a result, during the gap periods, it becomes possible to perform communication of the CSMA type between the GW 200 and the AP 300, between the neighboring APs 300, and between the AP 300 and the STA 400.

In this way, in the wireless communication system according to the first embodiment, as a result of effectively using the gap periods, communication of the TDD type and communication of the CSMA type can be performed in an efficient manner.

System Configuration

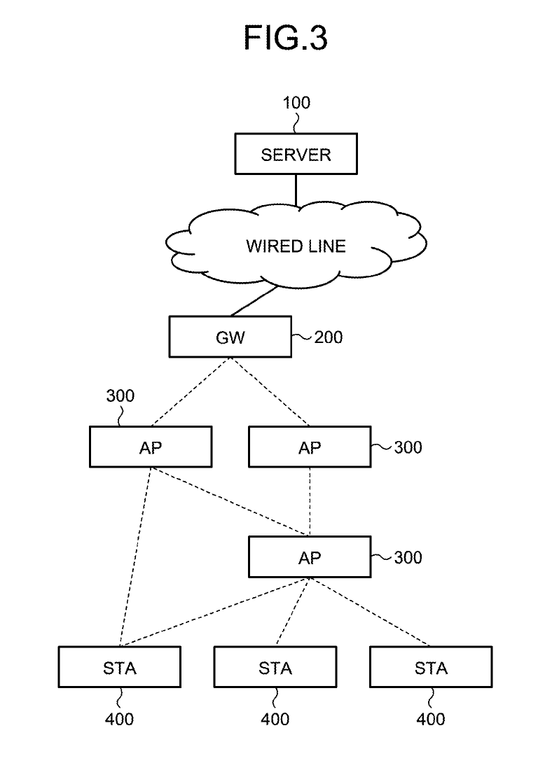

FIG. 3 is a block diagram illustrating an exemplary configuration of the wireless communication system according to the first embodiment. The wireless communication system according to the first embodiment includes the GW 200, a plurality of APs 300, a plurality of STAs 400, and the server 100. Herein, the server 100 is connected to the GW 200 via a wired line.

The server 100 performs monitoring control of the network and manages the TDD slots. Moreover, the server 100 stores the data collected via the network, and executes services in which the data is used. The GW 200 is a device that joins a wireless Wi-Fi network and a wired line. The APs 300 are wireless Wi-Fi access points and perform data transfer. The STAs 400 are information terminals such as tablets, or are sensor nodes (cordless extension units) with respect to the GW 200 (a base unit).

Server 100

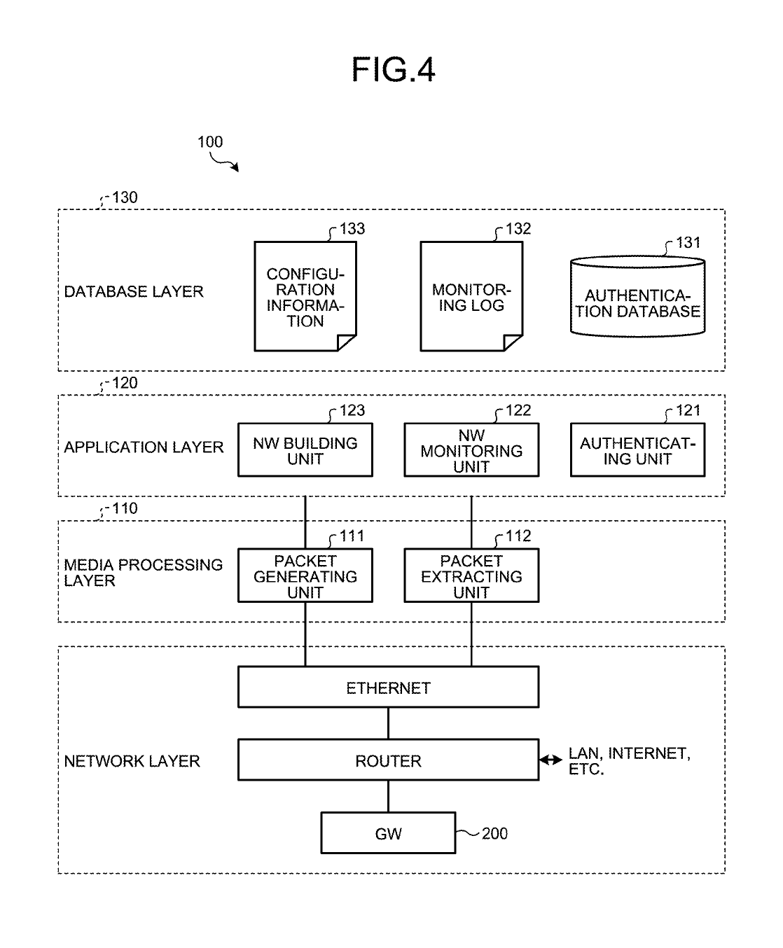

FIG. 4 is a block diagram illustrating an exemplary configuration of the server 100 of the wireless communication system according to the first embodiment. The server 100 includes a media processing layer 110, an application layer 120, and a database layer 130.

The media processing layer 110 includes a packet generating unit 111 and a packet extracting unit 112. The packet generating unit 111 generates packets that include the data received from the application layer 120, and sends the packets to the GW 200 via the Ethernet and a router of the network layer. The packet extracting unit 112 receives (extracts) packets from the network layer (the GW 200, the router, and the Ethernet), and outputs them to the application layer 120.

For example, in the case in which the server 100 implements an authentication service as a service, the application layer 120 includes an authenticating unit 121, and the database layer 130 includes an authentication database 131 (hereinafter, written as authentication DB 131). In this case, the authenticating unit 121 performs user authentication by collating data (such as a user name and a password), which is sent to the server 100 from the STA 400 via the APs 300 and the GW 200, with the data stored in the authentication DB 131.

The application layer 120 includes a network monitoring unit 122 (hereinafter, written as NW monitoring unit 122) and a network building unit 123 (hereinafter, written as NW building unit 123). The database layer 130 includes a monitoring log 132 indicating the records of a variety of data communication and includes configuration information 133 indicating the arrangement relationship of the GW 200, the APs 300, and the STAs 400. The NW monitoring unit 122 refers to the monitoring log 132 to monitor a variety of data communication in the network. The NW building unit 123 notifies the APs 300 and the STA 400 via the GW 200 about the data containing the configuration information 133, and accordingly performs network building and makes changes in the network building. That is, the GW 200, the APs 300, and the STAs 400 represent nodes assigned to the server 100 according to the configuration information 133.

GW

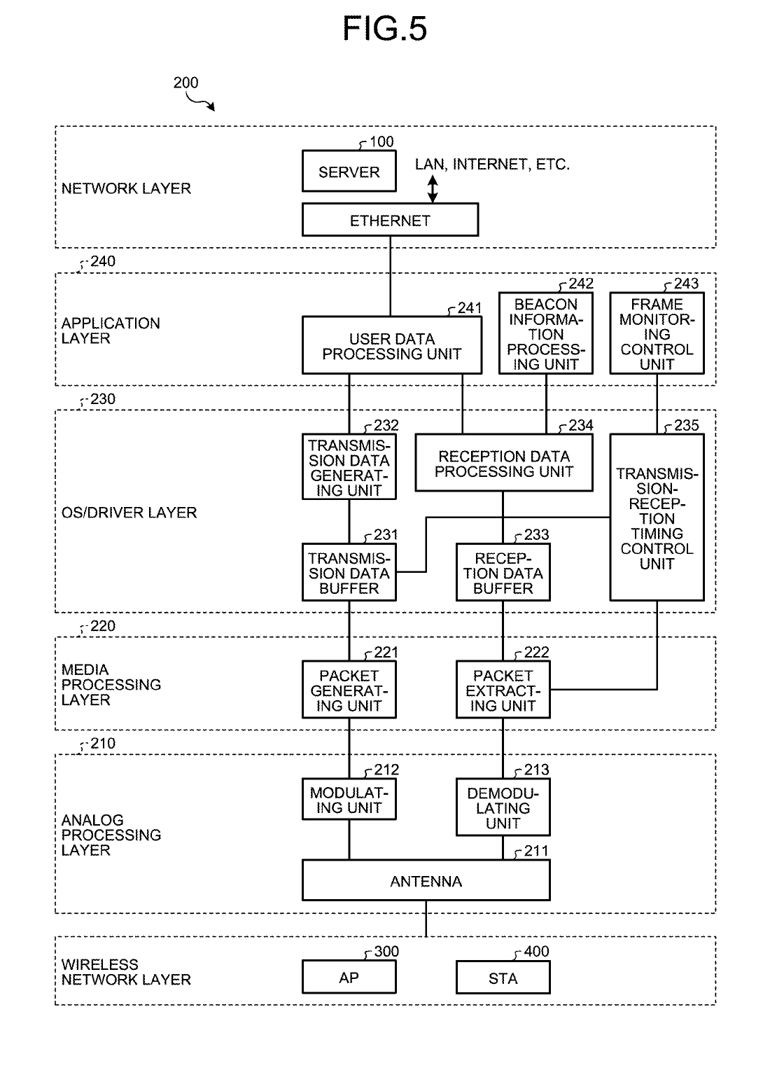

FIG. 5 is a block diagram illustrating an exemplary configuration of the GW 200 of the wireless communication system according to the first embodiment. The GW 200 includes an analog processing layer 210, a media processing layer 220, an operating system (0S)/driver layer 230, and an application layer 240. Herein, the analog processing layer 210, the media processing layer 220, the OS/driver layer 230, and the application layer 240 represent examples of a “notification information processing unit” of the GW 200.

The application layer 240 includes a user data processing unit 241 that sends data, which is received from the OS/driver layer 230 (i.e., information received from a wireless network), to the server 100 via the Ethernet of the network layer. Moreover, the user data processing unit 241 outputs data, which is received from the network layer (the server 100 and the Ethernet), to the OS/driver layer 230.

The OS/driver layer 230 includes a transmission data buffer 231, a transmission data generating unit 232, a reception data buffer 233, and a reception data processing unit 234. The transmission data generating unit 232 outputs data, which is received from the application layer 240, to the media processing layer 220 using the transmission data buffer 231. The reception data processing unit 234 outputs the data, which is received by the reception data buffer 233 from the media processing layer 220, to the application layer 240.

The media processing layer 220 includes a packet generating unit 221 and a packet extracting unit 222. The packet generating unit 221 generates packets that include data received from the OS/driver layer 230, and outputs the packets as signals to the analog processing layer 210. The packet extracting unit 222 extracts the packets from the signals received from the analog processing layer 210, and outputs the packets to the OS/driver layer 230.

The analog processing layer 210 includes an antenna 211, a modulating unit 212, and a demodulating unit 213. The antenna 211 sends signals, which are received from the modulating unit 212, to the wireless network (the APs 300 and the STAs 400); and outputs signals, which are received from the wireless network (the APs 300 and the STAs 400), to the demodulating unit 213. The modulating unit 212 modulates the signals, which are received from the media processing layer 220, and outputs the modulated signals to the antenna 211. The demodulating unit 213 demodulates the signals, which are received by the antenna 211, and outputs the demodulated signals to the media processing layer 220.

In this way, the GW 200 fulfils the role of a data bridge between a wireless network and a wired network.

Moreover, in the GW 200, the application layer 240 further includes a beacon information processing unit 242 and a frame monitoring control unit 243. The OS/driver layer 230 further includes a transmission-reception timing control unit 235. That is, the GW 200 includes the beacon information processing unit 242, the frame monitoring control unit 243, and the transmission-reception timing control unit 235 in addition to having the conventional functions. Herein, the beacon information processing unit 242, the frame monitoring control unit 243, and the transmission-reception timing control unit 235 represent examples of a “communication processing unit” of the GW 200. Regarding the beacon information processing unit 242, the frame monitoring control unit 243, and the transmission-reception timing control unit 235; the explanation is given later.

AP

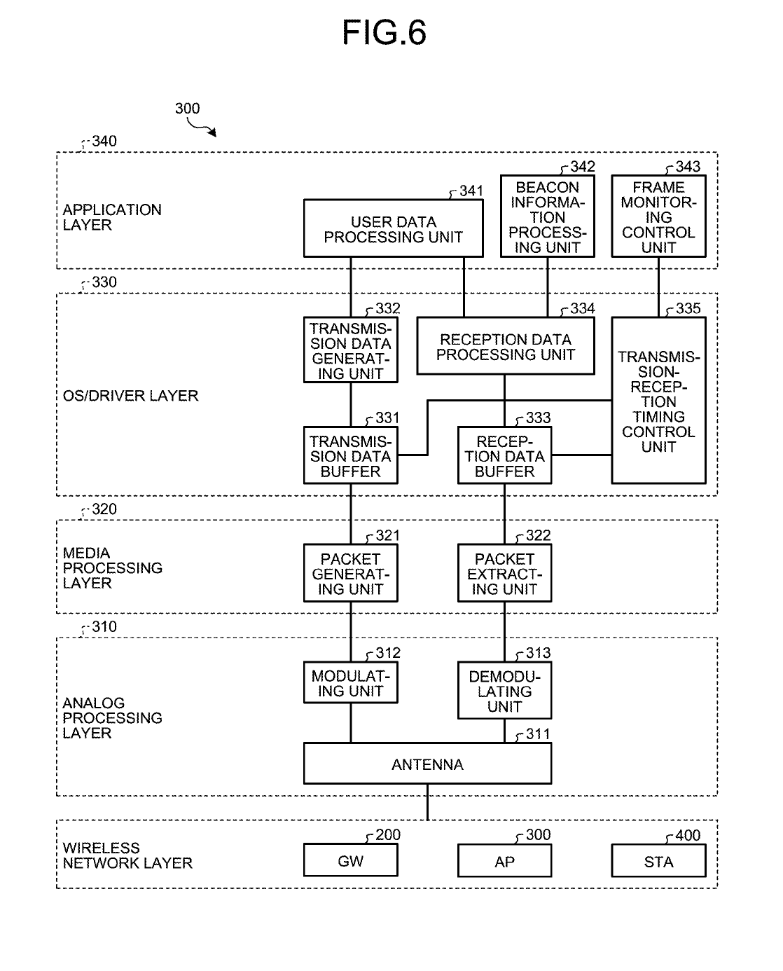

FIG. 6 is a block diagram illustrating an exemplary configuration of the AP 300 of the wireless communication system according to the first embodiment. The AP 300 includes an analog processing layer 310, a media processing layer 320, an OS/driver layer 330, and an application layer 340. Herein, the analog processing layer 310, the media processing layer 320, the OS/driver layer 330, and the application layer 340 represent examples of a “notification information processing unit” of the AP 300.

The application layer 340 includes a user data processing unit 341 that receives data from the OS/driver layer 330 (i.e., information sent from the wireless network). Moreover, the user data processing unit 341 outputs data to the OS/driver layer 330.

The OS/driver layer 330 includes a transmission data buffer 331, a transmission data generating unit 332, a reception data buffer 333, and a reception data processing unit 334. The transmission data generating unit 332 outputs data, which is received from the application layer 340, to the media processing layer 320 using the transmission data buffer 331. The reception data processing unit 334 outputs the data, which is received by the reception data buffer 333 from the media processing layer 320, to the application layer 340.

The media processing layer 320 includes a packet generating unit 321 and a packet extracting unit 322. The packet generating unit 321 generates packets that include data received from the OS/driver layer 330, and outputs the packets as signals to the analog processing layer 310. The packet extracting unit 322 extracts the packets from the signals received from the analog processing layer 310, and outputs the packets to the OS/driver layer 330.

The analog processing layer 310 includes an antenna 311, a modulating unit 312, and a demodulating unit 313. The antenna 311 sends signals, which are received from the modulating unit 312, to the wireless network (the GW 200, the APs 300, and the STAs 400); and outputs signals, which are received from the wireless network (the GW 200, the APs 300, and the STAs 400), to the demodulating unit 313. The modulating unit 312 modulates the signals, which are received from the media processing layer 320, and outputs the modulated signals to the antenna 311. The demodulating unit 313 demodulates the signals, which are received by the antenna 311, and outputs the demodulated signals to the media processing layer 320.

In this way, the AP 300 fulfils the role of bridging data, which is received from the STAs 400, to the wired network; and fulfils the role of bridging data to the other STAs 400 connected to the same AP 300. Moreover, in the first embodiment, the AP 300 is used as a multihop device. That is, the AP 300 fulfils the role of bridging information, which is received from the GW 200 or the AP 300 present in the upstream side, to the AP 300 or the STA 400 present in the downstream side; and fulfils the role of bridging information, which is received from the AP 300 or the STA 400 present in the downstream side, to the GW 200 or the AP 300 present in the upstream side.

Moreover, in the AP 300, the application layer 340 further includes a beacon information processing unit 342 and a frame monitoring control unit 343. The OS/driver layer 330 further includes a transmission-reception timing control unit 335. That is, the AP 300 includes the beacon information processing unit 342, the frame monitoring control unit 343, and the transmission-reception timing control unit 335 in addition to having the conventional functions. Herein, the beacon information processing unit 342, the frame monitoring control unit 343, and the transmission-reception timing control unit 335 represent examples of a “communication processing unit” of the AP 300. Regarding the beacon information processing unit 342, the frame monitoring control unit 343, and the transmission-reception timing control unit 335; the explanation is given later.

STA

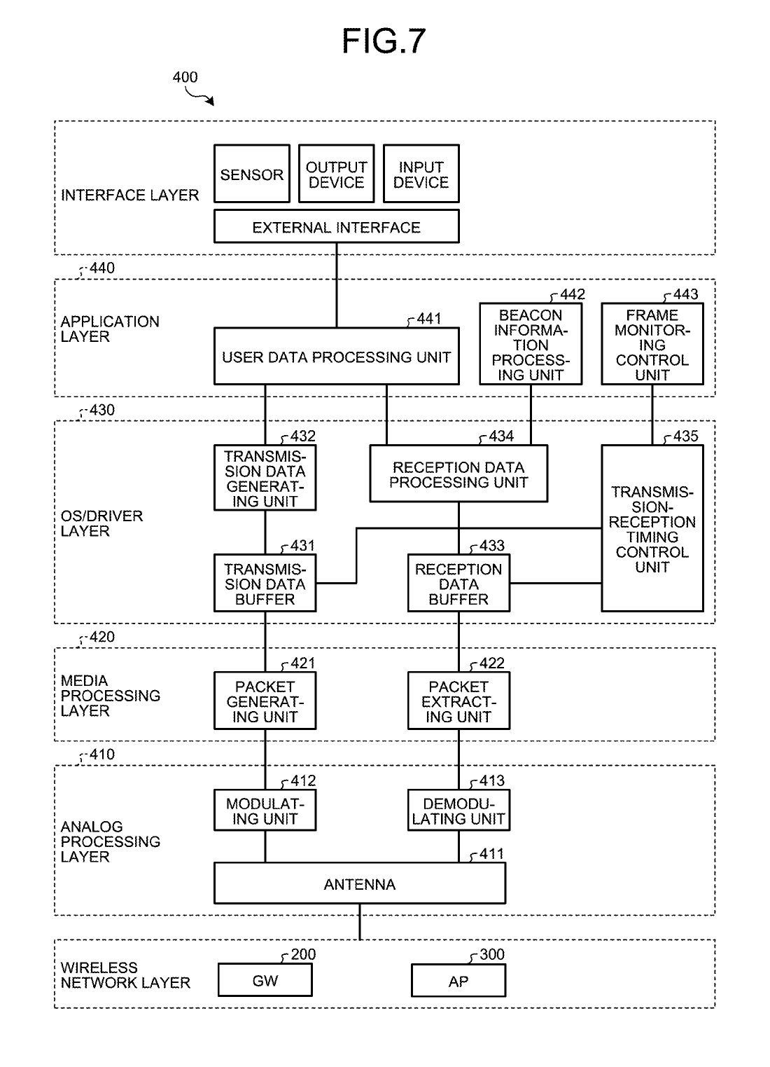

FIG. 7 is a block diagram illustrating an exemplary configuration of the STA 400 of the wireless communication system according to the first embodiment. The STA 400 includes an analog processing layer 410, a media processing layer 420, an OS/driver layer 430, an application layer 440, and an interface layer. Herein, the analog processing layer 410, the media processing layer 420, the OS/driver layer 430, and the application layer 440 represent examples of a “notification information processing unit” of the STA 400.

The interface layer includes sensors, output devices, and input devices. The output devices include a display device and a speaker. The input devices include a switch, such as a keyboard, and a microphone. The sensors, the output devices, and the input devices are connected to the application layer 440 via an external interface.

The application layer 440 includes a user data processing unit 441 that outputs data, which is received from the OS/driver layer 430 (i.e., information received from the wireless network), to the interface layer. Moreover, the user data processing unit 441 outputs data, which is received from the interface layer (i.e., information received from the sensors or information received from the input devices), to the OS/driver layer 430.

The OS/driver layer 430 includes a transmission data buffer 431, a transmission data generating unit 432, a reception data buffer 433, and a reception data processing unit 434. The transmission data generating unit 432 outputs data, which is received from the application layer 440, to the media processing layer 420 using the transmission data buffer 431. The reception data processing unit 434 outputs data, which is received by the reception data buffer 433, from the media processing layer 420 to the application layer 440.

The media processing layer 420 includes a packet generating unit 421 and a packet extracting unit 422. The packet generating unit 421 generates packets that include data received from the OS/driver layer 430, and outputs the packets as signals to the analog processing layer 410. The packet extracting unit 422 extracts the packets from the signals received from the analog processing layer 410, and outputs the packets to the OS/driver layer 430.

The analog processing layer 410 includes an antenna 411, a modulating unit 412, and a demodulating unit 413. The antenna 411 sends signals, which are received from the modulating unit 412, to the wireless network (the GW 200 and the APs 300); and outputs signals, which are received from the wireless network (the GW 200 and the APs 300), to the demodulating unit 413. The modulating unit 412 modulates the signals received from the media processing layer 420, and outputs the modulated signals to the antenna 411. The demodulating unit 413 demodulates the signals received by the antenna 411, and outputs the demodulated signals to the media processing layer 420.

In this way, the STA 400 fulfils the role of sending information, which is received from the sensors and the input devices, to the wireless network; and fulfils the role of outputting information, which is received from the wireless network, to the output devices.

Moreover, in the STA 400, the application layer 440 further includes a beacon information processing unit 442 and a frame monitoring control unit 443. The OS/driver layer 430 further includes a transmission-reception timing control unit 435. That is, the STA 400 includes the beacon information processing unit 442, the frame monitoring control unit 443, and the transmission-reception timing control unit 435 in addition to having the conventional functions. Herein, the beacon information processing unit 442, the frame monitoring control unit 443, and the transmission-reception timing control unit 435 represent examples of a “communication processing unit” of the STA 400. Regarding the beacon information processing unit 442, the frame monitoring control unit 443, and the transmission-reception timing control unit 435; the explanation is given later.

Example of Frame Configuration

Given below is the explanation of an exemplary frame configuration for enabling efficient communication of the TDD type and enabling efficient communication of the CSMA type.

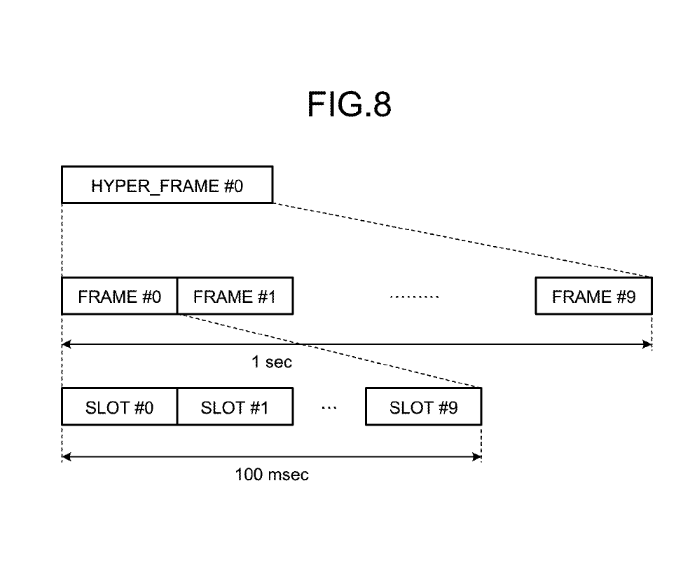

FIG. 8 is a block diagram illustrating an exemplary frame configuration in the wireless communication system according to the first embodiment. In FIG. 8, “HYPER_FRAME #0” is a hyper frame representing the unit at which an arbitrary slot assignment can be done, and illustrates an example of a single hyper frame. Moreover, in FIG. 8, “FRAME #0”, “FRAME #1”, . . . , “FRAME #9” are frames representing the unit for sending beacon information (notification information), and illustrate an example of the frames assigned to a single hyper frame. Furthermore, in FIG. 8, “SLOT #0”, “SLOT #1”, . . . , “SLOT #9” are slots representing the smallest unit at which TDMA assignment or CSMA assignment is specified, and illustrate an example of the slots assigned to a single frame.

In the example illustrated in FIG. 8, in the hyper frame (1 second), 100 slots can be assigned at the unit of 10 milliseconds. The server 100 delivers the assignment of the communication method as beacon information to the entire network. The beacon information is once sent in the vicinity of the start of a frame (100 milliseconds). For example, the beacon information is assigned to the first slot (“SLOT #0”) among a plurality of slots (“SLOT #0”, “SLOT #1”, . . . , “SLOT #9”) assigned to a single frame. Then, since the information related to slot assignment is included in the first slot, as far as changing slot assignment of the entire network is concerned, the setting can be changed at the unit of 100 milliseconds at the minimum.

Method for Recognizing Starting Position of Frame

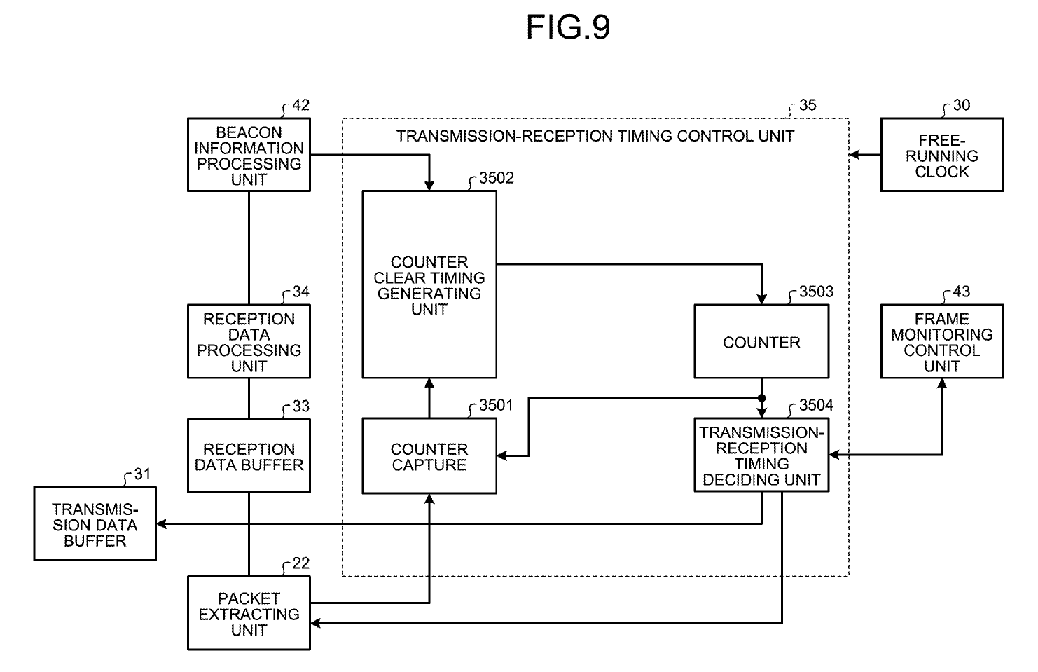

Given below is the explanation of a transmission-reception timing control unit meant for recognizing the starting position of a frame. FIG. 9 is a block diagram illustrating an exemplary configuration of a transmission-reception timing control unit 35 of the GW 200, the APs 300, and the STAs 400 in the wireless communication system according to the first embodiment.

With reference to FIG. 9, the transmission-reception timing control unit 35 is equivalent to the transmission-reception timing control unit 235 of the GW 200, the transmission-reception timing control unit 335 of the AP 300, and the transmission-reception timing control unit 435 of the STA 400. Moreover, with reference to FIG. 9, a beacon information processing unit 42 is equivalent to the beacon information processing unit 242 of the GW 200, the beacon information processing unit 342 of the AP 300, and the beacon information processing unit 442 of the STA 400. Furthermore, with reference to FIG. 9, a frame monitoring control unit 43 is equivalent to the frame monitoring control unit 243 of the GW 200, the frame monitoring control unit 343 of the AP 300, and the frame monitoring control unit 443 of the STA 400.

In an identical manner, with reference to FIG. 9, a packet extracting unit 22 is equivalent to the packet extracting unit 22 of the GW 200, the packet extracting unit 322 of the AP 300, and the packet extracting unit a of the STA 400. Moreover, with reference FIG. 9, a transmission data buffer 31 is equivalent to the transmission data buffer 231 of the GW 200, the transmission data buffer 331 of the AP 300, and the transmission data buffer 431 of the STA 400. Furthermore, with reference to FIG. 9, a reception data buffer 33 is equivalent to the reception data buffer 233 of the GW 200, the reception data buffer 333 of the AP 300, and the reception data buffer 433 of the STA 400. Moreover, with reference to FIG. 9, a reception data processing unit 34 is equivalent to the reception data processing unit 234 of the GW 200, the reception data processing unit 334 of the AP 300, and the reception data processing unit 434 of the STA 400.

As illustrated in FIG. 9, the transmission-reception timing control unit 35 operates according to a free-running clock 30 installed therein. The transmission-reception timing control unit 35 includes a counter capture 3501, a counter clear timing generating unit 3502, a counter 3503, and a transmission-reception timing deciding unit 3504.

Firstly, when all packets that include beacon information are detected (extracted), the packet extracting unit 22 sends a capture trigger to the counter capture 3501 of the transmission-reception timing control unit 35. The counter capture 3501 sets, as the beacon reception timing, the timing of receiving the capture trigger from the packet extracting unit 22. Then, the reception data processing unit 34 receives the packets from the packet extracting unit 22 via the reception data buffer 33; recognizes that the packets include beacon information; and notifies the beacon information processing unit 42 about the beacon information. The beacon information contains a slot number, a frame number, and an in-slot delay period representing the delay in slot units. Then, the beacon information processing unit 42 notifies the counter clear timing generating unit 3502 about the beacon information (the slot number, the frame number, and the in-slot delay period).

The counter clear timing generating unit 3502 calculates the hyper frame starting timing based on the beacon reception timing received from the counter capture 3501 and based on the beacon information (the slot number, the frame number, and the in-slot delay period) received from the beacon information processing unit 42. Herein, N_{SLOT} represents the slot number; the slot duration is set to 10 [msec]; N_{FRAME} represents the frame number; the frame duration is set to 100 [msec]; and Δt represents the in-slot delay time. Moreover, if T_{Beacon} represents the beacon reception timing and if T_{HYPER}_{_}_{FRAME} represents the hyper frame starting timing, then the hyper frame starting timing T_{HYPER}_{_}_{FRAME} is calculated using the following equation.

$${T}_{HYPER \_ FRAME} = {T}_{Beacon} - {N}_{SLOT} \times 10 [ m sec ] - {N}_{FRAME} \times 100 [ m sec ] - Δ t$$

At the timing of calculation of the hyper frame starting timing, the counter clear timing generating unit 3502 clears the counter value of the counter 3503. As a result, the transmission-reception timing deciding unit 3504 becomes able to recognize the position of the counter value “0” of the counter 3503. Moreover, since the transmission-reception timing deciding unit 3504 becomes able to recognize the position of the counter value “0” of the counter 3503, the frame monitoring control unit 43 becomes able to recognize the start of the frame. According to the recognized counter value and according to the start of the frame as recognized by the frame monitoring control unit 43, the transmission-reception timing deciding unit 3504 decides on the transmission-reception timing of the slots and the frames. Then, the transmission-reception timing deciding unit 3504 notifies the packet extracting unit 22 and the transmission data buffer 31 about enable control information indicating the decided transmission-reception timing, and thus assigns the time periods of the TDD type (“TDMA downlink” and “TDMA uplink” illustrated in FIG. 2).

Moreover, the transmission-reception timing deciding unit 3504 assigns the time periods of the CSMA type (“CSMA” illustrated in FIG. 2) between the downlink time periods of the TDD type (“TDMA downlink” illustrated in FIG. 2) and the uplink time periods of the TDD type (“TDMA uplink” illustrated in FIG. 2). That is, the transmission-reception timing deciding unit 3504 assigns the time periods of the CSMA type during the gap periods.

Specific Example

Explained below with reference to FIG. 2 are the operations performed in the wireless communication system according to the first embodiment.

For example, the GW 200 receives, from the server 100, beacon information in which the starting position of frame is specified. Then, based on the beacon information and the beacon reception timing at which the beacon information is received, the GW 200 calculates the hyper frame starting timing. According to the calculated hyper frame starting timing, the GW 200 assigns the hyper frame therein. That is, the GW 200 assigns the time periods of the TDD type (“TDMA downlink” and “TDMA uplink” illustrated in FIG. 2), and assigns the time periods of the CSMA type (“CSMA” illustrated in FIG. 2) during the periods of time that are present between the time periods of the TDD type and that represent predetermined gap periods. Moreover, in the frame, the GW 200 sends the beacon information in the time period of the slot “SLOT #0”.

The AP 300 identified as “AP #1” and representing the neighboring node to the GW 200 receives the beacon information that is sent in the time period of the slot “SLOT #0” from the GW 200. Then, based on the beacon information and the beacon reception timing at which the beacon information is received, the AP 300 identified as “AP #1” calculates the hyper frame starting timing. According to the calculated hyper frame starting timing, the AP 300 identified as “AP #1” assigns the hyper frame therein. That is, the AP 300 identified as “AP #1” assigns the time periods of the TDD type (“TDMA downlink” and “TDMA uplink” illustrated in FIG. 2), and assigns the time periods of the CSMA type (“CSMA” illustrated in FIG. 2) during the periods of time that are present between the time periods of the TDD type and that represent predetermined gap periods. Herein, the downlink time periods of the TDD type (“TDMA downlink” illustrated in FIG. 2) as assigned to the AP 300 identified as “AP #1” are delayed with respect to the downlink time periods of the TDD type (“TDMA downlink” illustrated in FIG. 2) as assigned to the GW 200. Moreover, the uplink time periods of the TDD type (“TDMA uplink” illustrated in FIG. 2) as assigned to the GW 200 are delayed with respect to the uplink time periods of the TDD type (“TDMA uplink” illustrated in FIG. 2) as assigned to the AP 300 identified as “AP #1”. In the concerned frame, the AP 300 identified as “AP #1” sends beacon information in the time period of the slot “SLOT #0”.

The AP 300 identified as “AP #2” and representing the neighboring node to the AP 300 “identified as “AP #1” receives beacon information sent in the time period of the slot “SLOT #0” from the AP 300 identified as “AP #1”. Then, based on the beacon information and the beacon reception timing at which the beacon information is received, the AP 300 identified as “AP #2” calculates the hyper frame starting timing. According to the calculating hyper frame starting timing, the AP 300 identified as “AP #2” assigns the hyper frame therein. That is, the AP 300 identified as “AP #2” assigns the time periods of the TDD type (“TDMA downlink” and “TDMA uplink” illustrated in FIG. 2), and assigns the time periods of the CSMA type (“CSMA” illustrated in FIG. 2) during the periods of time that are present between the time periods of the TDD type and that represent predetermined gap periods. Herein, the downlink time periods of the TDD type (“TDMA downlink” illustrated in FIG. 2) as assigned to the AP 300 identified as “AP #2” are delayed with respect to the downlink time periods of the TDD type (“TDMA downlink” illustrated in FIG. 2) as assigned to the AP 300 identified as “AP #1”. Moreover, the uplink time periods of the TDD type (“TDMA uplink” illustrated in FIG. 2) as assigned to the AP 300 identified as “AP #1” are delayed with respect to the uplink time periods of the TDD type (“TDMA uplink” illustrated in FIG. 2) as assigned to the AP 300 identified as “AP #2”. In the concerned frame, the AP 300 identified as “AP #2” sends beacon information in the time period of the slot “SLOT #0”.

The STA 400 that represents the neighboring node to the AP 300 identified as “AP #2” receives the beacon information sent in the time period of the slot “SLOT #0” from the AP 300 identified as “AP #2”. Then, based on the beacon information and the beacon reception timing at which the beacon information is received, the STA 400 calculates the hyper frame starting timing. According to the calculated hyper frame starting timing, the STA 400 assigns the hyper frame therein. That is, the STA 400 assigns the time periods of the TDD type (“TDMA downlink” and “TDMA uplink” illustrated in FIG. 2), and assigns the time periods of the CSMA type (“CSMA” illustrated in FIG. 2) during the periods of time that are present between the time periods of the TDD type and that represent predetermined gap periods. Herein, the downlink time periods of the TDD type (“TDMA downlink” illustrated in FIG. 2) as assigned to the STA 400 are delayed with respect to the downlink time periods of the TDD type (“TDMA downlink” illustrated in FIG. 2) as assigned to the AP 300 identified as “AP #2”. Moreover, the uplink time periods of the TDD type (“TDMA uplink” illustrated in FIG. 2) as assigned to the AP 300 identified as “AP #2” are delayed with respect to the uplink time periods of the TDD type (“TDMA uplink” illustrated in FIG. 2) as assigned to the STA 400.

Effect

As described above, the wireless communication system according to the first embodiment includes the server 100 and includes a plurality of wireless communication devices (the GW 200, the APs 300, and the STAs 400) representing the nodes assigned to the server 100. The server 100 sends notification information (beacon information) in which the starting positions of frames are specified. Each of a plurality of wireless communication devices includes a notification information processing unit and a communication processing unit.

The notification information processing unit receives the beacon information. For example, when the GW 200 represents the wireless communication device, the notification information processing unit includes the analog processing layer 210, the media processing layer 220, the OS/driver layer 230, and the application layer 240. Alternatively, when the AP 300 represents the wireless communication device, the notification information processing unit includes the analog processing layer, the media processing layer 320, the OS/driver layer 330, and the application layer 340. Still alternatively, for example, when the STA 400 represents the wireless communication device, the notification information processing unit includes the analog processing layer 410, the media processing layer 420, the OS/driver layer 430, and the application layer 440.

According to the beacon information, the communication processing unit performs communication of the TDD type, and performs communication of the CSMA type during the periods of time between the downlink time periods and the uplink time periods of the TDD type. For example, when the GW 200 represents the wireless communication device, the communication processing unit includes the transmission-reception timing control unit 235, the beacon information processing unit 242, and the frame monitoring control unit 243. Alternatively, for example, when the AP 300 represents the wireless communication device, the communication processing unit includes the transmission-reception timing control unit 335, the beacon information processing unit 342, and the frame monitoring control unit 343. Still alternatively, when the STA 400 represents the wireless communication device, the communication processing unit includes the transmission-reception timing control unit 435, the beacon information processing unit 442, and the frame monitoring control unit 443.

In this way, in the wireless communication system according to the first embodiment, the server 100 sends beacon information; and the GW 200, the APs 300, and the STAs 400 perform communication of the TDD type and perform communication of the CSMA type during the gap periods according to the beacon information. As a result, during the gap periods, communication of the CSMA type can be performed between the GW 200 and the AP 300, between the neighboring APs 300, and between the AP 300 and the STA 400. Thus, in the wireless communication system according to the first embodiment, the gap periods are used in an effective manner, thereby enabling efficient communication of the TDD type and efficient communication of the CSMA type.

### [b] Second Embodiment

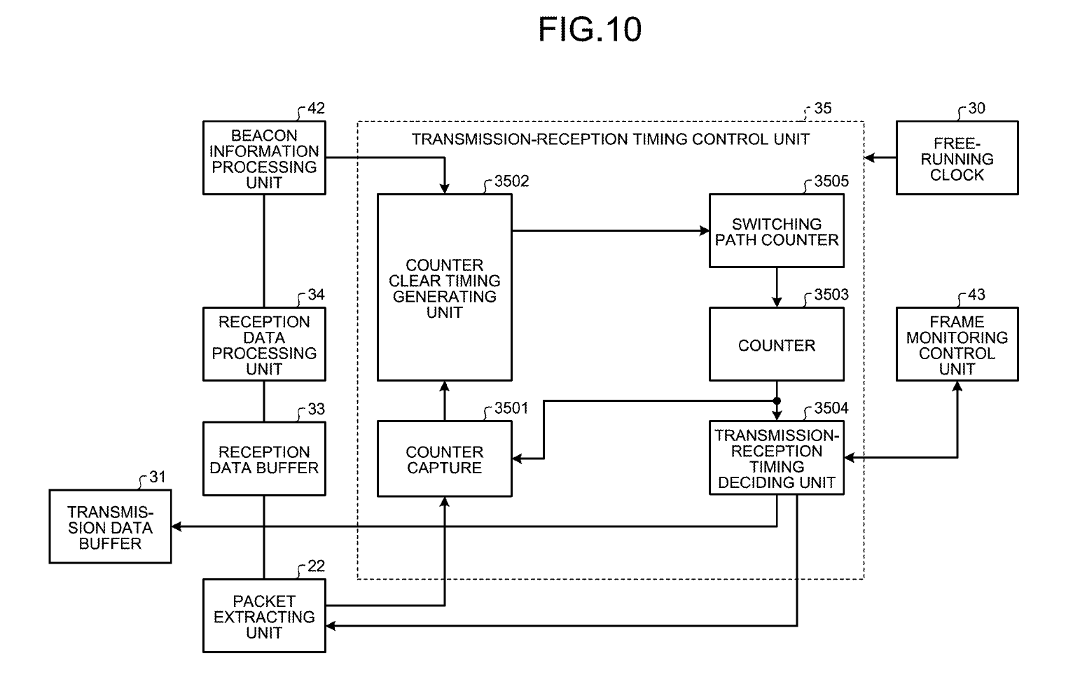

FIG. 10 is a block diagram illustrating an exemplary configuration of the transmission-reception timing control unit 35 of the GW 200, the APs 300, and the STAs 400 of the wireless communication system according to a second embodiment. The transmission-reception timing control unit 35 includes a switching path counter 3505 in addition to having the configuration illustrated in FIG. 9.

Issues

As one of the features of multihop communication, path switching is known in which, when the AP 300 malfunctions thereby resulting in a state in which data communication is not normally performed between the GW 200 and the STA 400, data is sent using another path. As a result of performing path switching, it becomes possible to enhance the data arrival factor between the GW 200 and the STA 400. Thus, path switching is given importance in factories in which a large volume of data is communicated or in the Internet of Things (IoT) technology.

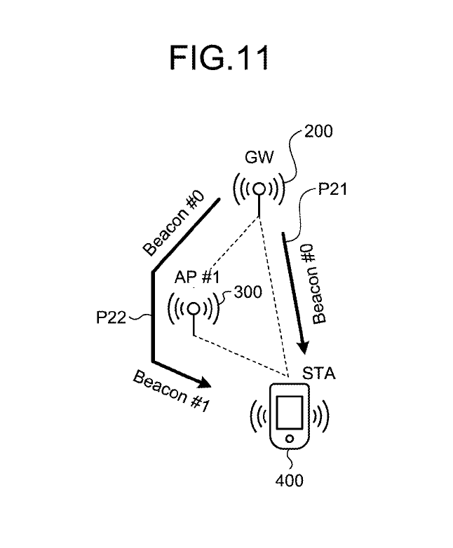

FIG. 11 is a diagram for explaining the issues arising in the wireless communication system according to the second embodiment. For example, in a path P21, beacon information #0 (“Beacon #0” illustrated in FIG. 11) is sent from the GW 200 to the STA 400. In a path P22, the beacon information #0 is sent from the GW 200 to the AP 300 (identified as “AP #1” illustrated in FIG. 11), and beacon information #1 (“Beacon #1” illustrated in FIG. 11) is sent from the AP 300 identified as “AP #1” to the STA 400.

In this case, in order to perform path switching at a faster pace during multihop communication, it is desirable that control is performed to ensure that both sets of beacon information are constantly receivable, and that the frame starting position is recognizable based on the beacon information in both paths (the communication path and the switching path). At the time of receiving the beacon information in the communication path, the transmission-reception timing control unit 35 clears the counter value of the counter 3503 according to the frame starting position. On the other hand, when the beacon information in the switching path is received, the transmission-reception timing control unit 35 clears the counter value of the switching path counter 3505 according to the frame starting position. The transmission-reception timing control unit 35 includes the switching path counter 3505. Hence, when path switching is performed, the counter value of the switching path counter 3505 is loaded in the counter 3503 meant for frame generation. As a result, the frame starting position can be changed in a short period of time.

However, when the position of the beacon information is defined to be the starting criterion as is the case in a normal Wi-Fi system, in the case of performing multihop communication, it is sometimes difficult for the STA 400 to receive both sets of beacon information due to issues (1) and (2) given below.

Issue (1)

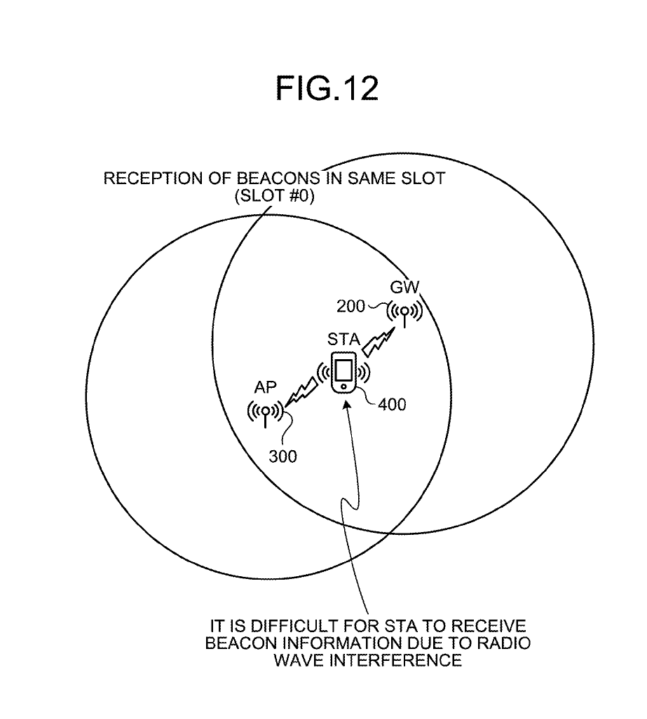

FIG. 12 is a diagram for explaining the issue (1) arising in the wireless communication system according to the second embodiment. With reference to FIG. 12, the GW 200 and the AP 300 use the same channel. In this case, when the GW 200 and the AP 300 send beacon information at the frame starting position, the sets of beacon information sent from the GW 200 and the AP 300 interfere in the STA 400. That is, there occurs a packet reception trouble attributed to radio wave interference. In this case, there is a possibility that the STA 400 does not receive the beacon information.

Issue (2)

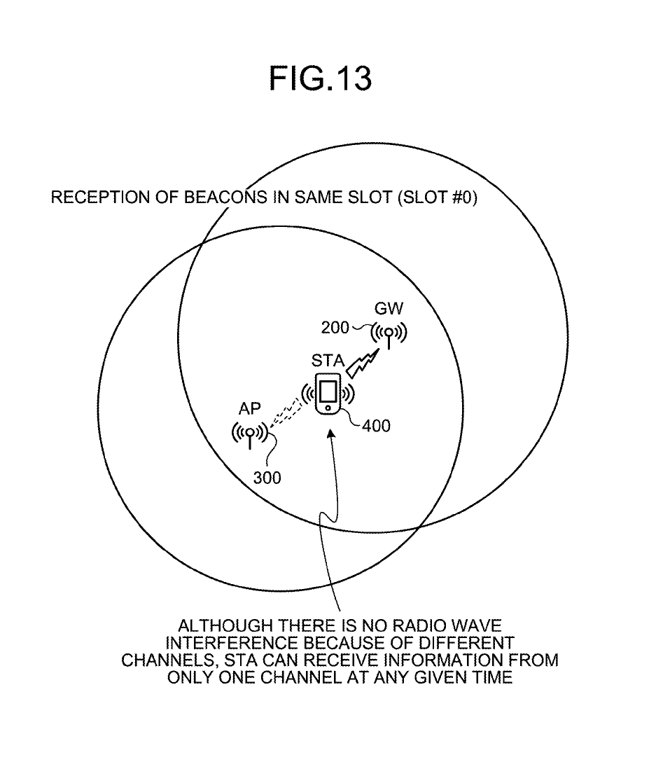

FIG. 13 is a diagram for explaining the issue (2) arising in the wireless communication system according to the second embodiment. With reference to FIG. 13, the GW 200 and the AP 300 use different channels. In this case, the number of channels receivable by the STA 400 in one instance (that is, at the same timing) is one. Hence, the STA 400 can receive any one set of beacon information (for example, the beacon information sent from the GW 200) but does not receive the other set of beacon information (for example, the beacon information sent from the AP 300).

### Solution

In the wireless communication system according to the second embodiment, the positions of the slots in which the beacon information sent from the GW 200 and the AP 300 is assigned are shifted. For example, in a particular frame, a nod hop count indicating the involved node count is set; and, at the time of receiving or transferring the beacon information, the node hop count is incremented by one. In a plurality of paths P21 and P22 meant for transferring the beacon information, the GW 200 and the AP 300 assign beacon information to the slots present at the positions corresponding to the node hop count among a plurality of slots. With that, the abovementioned issues get resolved.

In a frame, the GW 200 sends beacon information in the time period of the slot “SLOT #0”. Moreover, the AP 300 uses the neighboring slot according to the node hop count (for example, uses the slot “SLOT #1” when the node hop count is one, and uses the slot “SLOT #2” when the node hop count is two”). Moreover, in the time period of the slot in which the GW 200 and the neighboring AP 300 send beacon information, the GW 200 and the neighboring AP 300 switch to the standby state or the reception state and stop any transmission in the time period of that slot.

Solution (1)

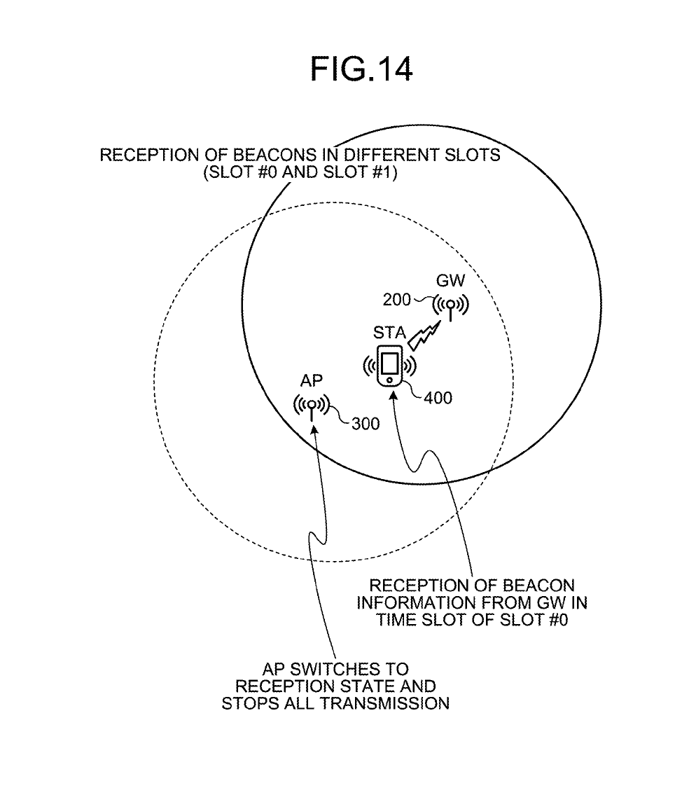

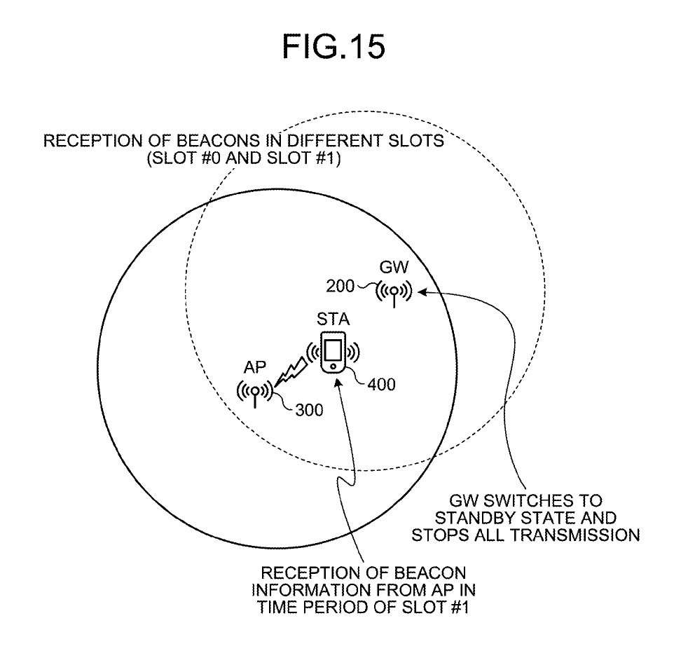

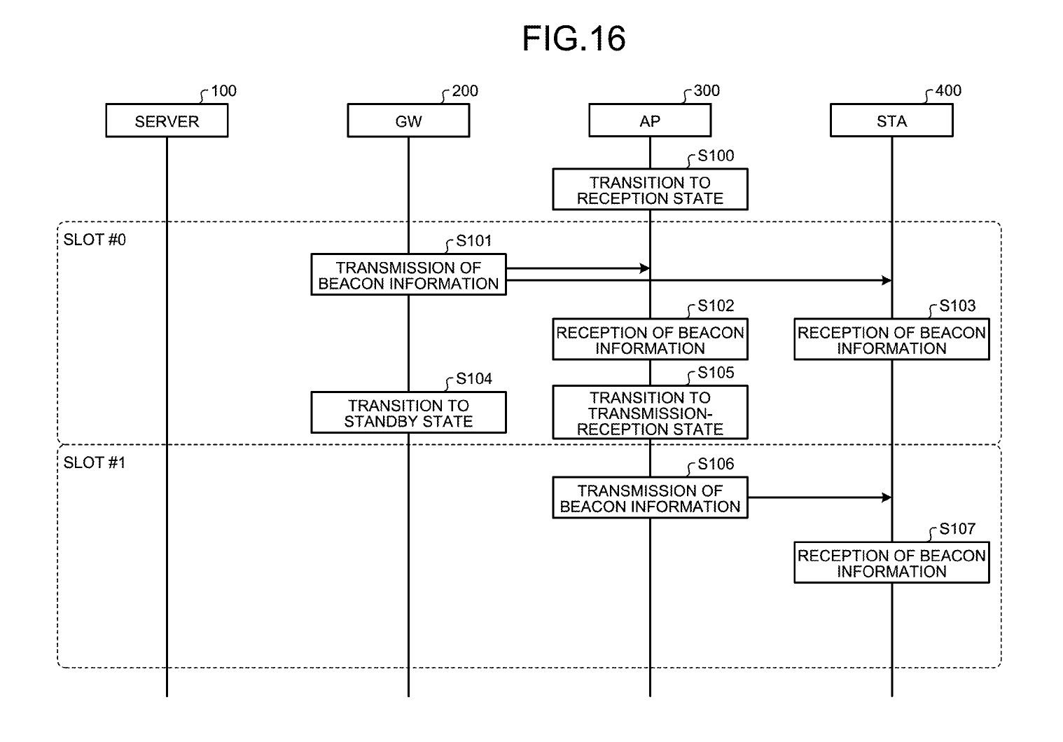

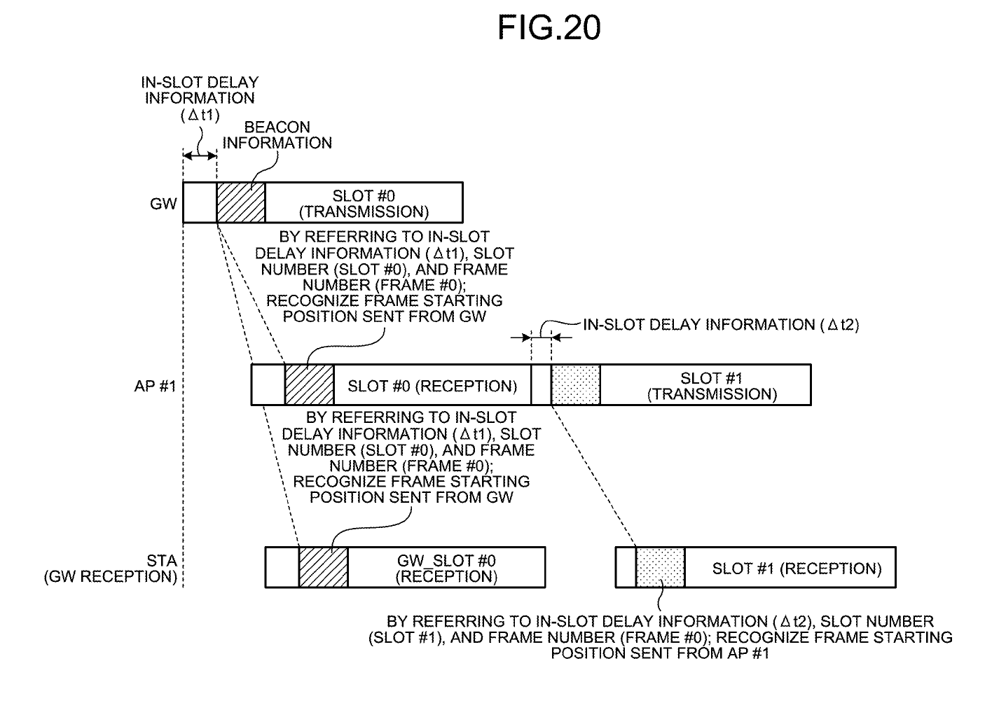

FIGS. 14 and 15 are diagrams for explaining a solution to the issue (1) arising in the wireless communication system according to the second embodiment. FIG. 16 is a sequence diagram illustrating an exemplary solution to the issue (1) in the wireless communication system according to the second embodiment. FIG. 20 is a diagram for explaining the solutions in the wireless communication system according to the second embodiment.

With reference to FIGS. 14 and 15, the GW 200 and the AP 300 use the same channel.

In this case, with reference to FIGS. 14 and 20, the AP 300 representing the neighboring node to the GW 200 switches to the reception state and stops all transmission (Step S100 illustrated in FIG. 16). At that time, in the concerned frame, the GW 200 sends beacon information in the time period of the slot “SLOT #0” (Step S101 illustrated in FIG. 16). The AP 300 representing the neighboring node of the GW 200 receives the beacon information sent from the GW 200 in the time period of the slot “SLOT #0” (Step S102 illustrated in FIG. 16). Moreover, the STA 400 representing the neighboring node to the GW 200 and the AP 300 receives the beacon information sent from the GW 200 in the time period of the slot “SLOT #0” (Step S103 illustrated in FIG. 16).

Subsequently, with reference to FIGS. 15 and 20, the GW 200 switches to the standby state after sending the beacon information in the time period of the slot “SLOT #0”, and stops all transmission (Step S104 illustrated in FIG. 16). At that time, the AP 300 representing the neighboring node to the GW 200 switches to the transmission-reception state to be able to perform transmission (Step S105 illustrated in FIG. 16), and sends beacon information in the time period of the slot “SLOT #1” (Step S106 illustrated in FIG. 16). The STA 400 representing the neighboring node to the GW 200 and the AP 300 receives the beacon information sent from the AP 300 in the time period of the slot “SLOT #1” (Step S107 illustrated in FIG. 16).

In this way, even when the GW 200 and the AP 300 are using the same channel, the beacon information sent from the GW 200 and the beacon information sent from the AP 300 have a sufficiently-offset time interval therebetween. Hence, in the wireless communication system according to the second embodiment, the packets that include beacon information and that are sent from the GW 200 and the AP 300 do not interfere (are not caught in radio wave interference), and the STA 400 becomes able to receive the beacon information.

Solution (2)

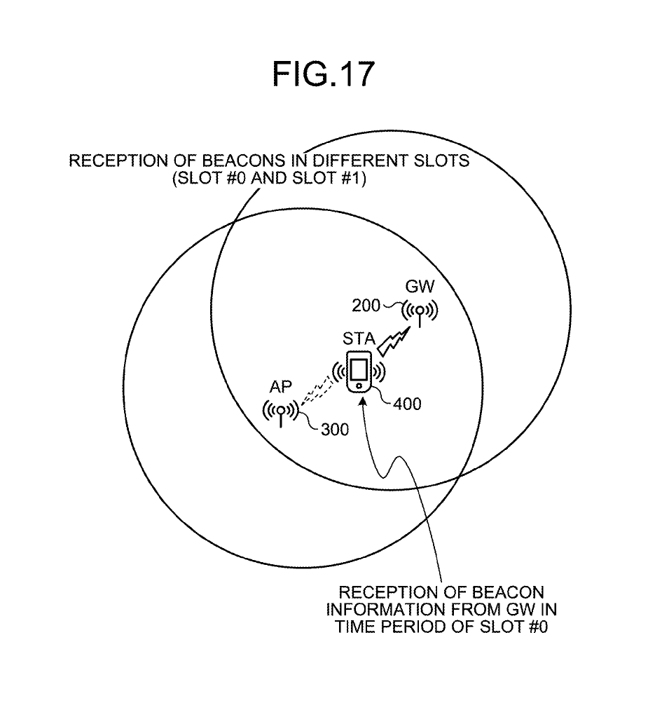

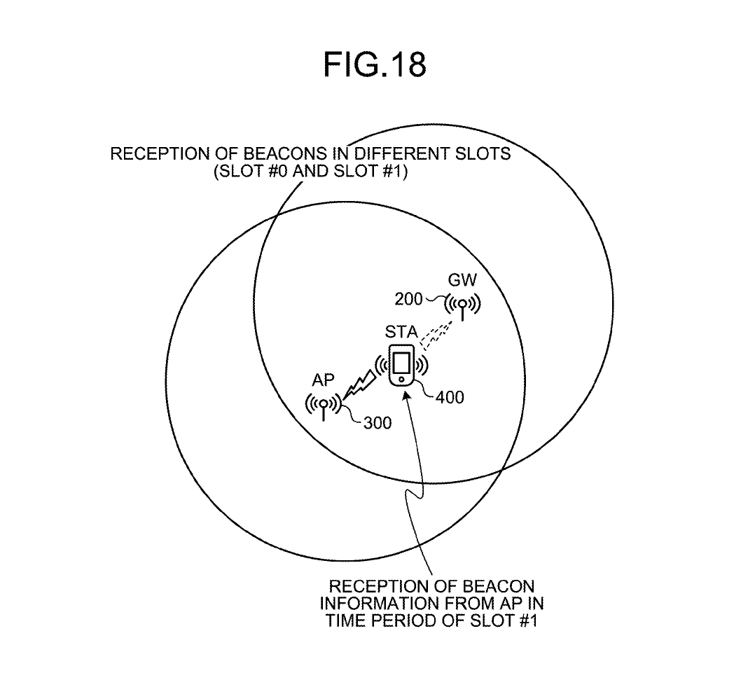

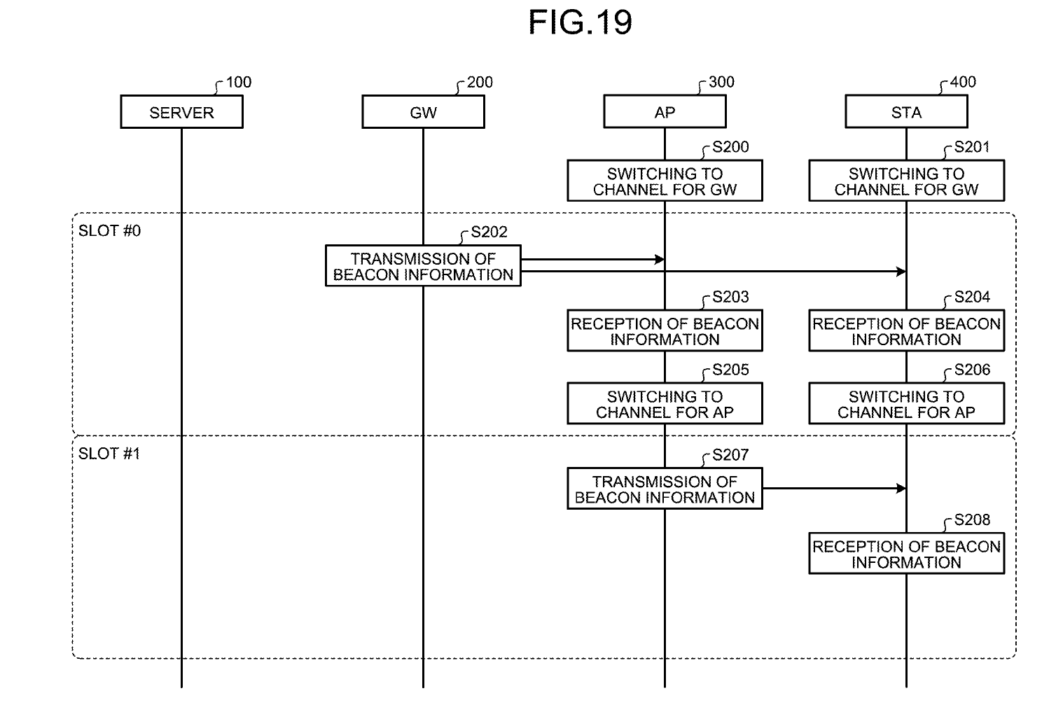

FIGS. 17 and 18 are diagrams for explaining a solution to the issue (2) in the wireless communication system according to the second embodiment. FIG. 19 is a sequence diagram illustrating an exemplary solution to the issue (2) in the wireless communication system according to the second embodiment.

With reference to FIGS. 17 and 18, the GW 200 and the AP 300 use different channels.

In this case, with respect to FIGS. 17 and 20, the AP 300 representing the neighboring node to the GW 200 switches to the channel for the GW 200 (Step S200 illustrated in FIG. 19). In an identical manner, the STA 400 representing the neighboring node to the GW 200 and the AP 300 switches to the channel for the GW 200 (Step S201 illustrated in FIG. 19). At that time, the GW 200 sends beacon information in the time period of the slot “SLOT #0” (Step S202 illustrated in FIG. 19). The AP 300 representing the neighboring node to the GW 200 receives the beacon information sent from the GW 200 in the time period of the slot “SLOT #0” (Step S203 illustrated in FIG. 19). Moreover, the STA 400 representing the neighboring node to the GW 200 and the AP 300, receives the beacon information sent from the GW 200 in the time period of the slot “SLOT #0” (Step S204 illustrated in FIG. 19).

Subsequently, with reference to FIGS. 18 and 20, when the beacon information is received from the GW 200, the AP 300 representing the neighboring node to the GW 200 switches to the channel for the AP 300 (Step S205 illustrated in FIG. 19). In an identical manner, when the beacon information is received from the GW 200; the STA 400 representing the neighboring node to the GW 200 and the AP 300 switches to the channels for the AP 300 (Step S206 illustrated in FIG. 19). At that time, the AP 300 representing the neighboring node to the GW 200 sends beacon information in the time period of the slot “SLOT #1” (Step S207 illustrated in FIG. 19). The STA 400 representing the neighboring node to the GW 200 and the AP 300 receives the beacon information sent from the AP 300 in the time period of the slot “SLOT #1” (Step S208 illustrated in FIG. 19).

In this way, even when the GW 200 and the AP 300 are using different channels, the beacon information sent from the GW 200 and the beacon information sent from the AP 300 have a sufficiently-offset time interval therebetween. Hence, in the wireless communication system according to the second embodiment, a channel switching period can be secured in the STA 400, and the STA 400 becomes able to receive the beacon information sent from the GW 200 and the beacon information sent from the AP 300.

As another advantage, the latest information in the beacon information can be sent in the same frame. The beacon information contains information meant for communicating the information from the GW 200 without modification and contains information added in the APs 300. In the wireless communication system according to the second embodiment, at the same timing, the beacon information from each AP 300 gets delayed by one frame. On the other hand, in the wireless communication system according to the second embodiment, by shifting the position of the beacon information by one slot at a time, the beacon information received in the same frame can be sent without modification.

Effect

As described above, in the wireless communication system according to the second embodiment, among a plurality of slots identified as “SLOT #0”, “SLOT #1”, . . . , “SLOT #9” assigned to a single frame, the notification information (beacon information) is assigned to the first slot “SLOT #0”. The notification information processing unit of a plurality of wireless communication devices (in this case, the GW 200 and the AP 300) assigns, in a plurality of paths P21 and P22 in which the beacon information is transferred, the beacon information in the slots present at the positions corresponding to the node hop count indicating the involved node count.

For example, when the GW 200 represents the wireless communication device, the notification information processing unit includes the analog processing layer 210, the media processing layer 220, the OS/driver layer 230, and the application layer 240. In that case, the notification information processing unit of the GW 200 (for example, the transmission-reception timing control unit 235 of the OS/driver layer 230) assigns, in the path P21, the beacon information in the slot “SLOT #0” that, among a plurality of slots, is present at the position corresponding to the node hop count of zero.

For example, when the AP 300 represents the wireless communication device, the notification information processing unit includes the analog processing layer 310, the media processing layer 320, the OS/driver layer 330, and the application layer 340. In this case, the notification information processing unit of the AP 300 (for example, the transmission-reception timing control unit 335 of the OS/driver layer 330) assigns, in the path P22, the beacon information in the slot “SLOT #1” that, among a plurality of slots, is present at the position corresponding to the node hop count of one.

In this way, in the wireless communication system according to the second embodiment, as a result of shifting the position of the beacon information by one slot at a time, the STA 400 can receive the beacon information regardless of whether the same channel is used or different channels are used.

### [c] Third Embodiment

In the wireless communication system according to the second embodiment, the position of the beacon information is shifted by one slot at a time. However, when a plurality of paths having the same node hop count is present, the following issues arise.

Issues

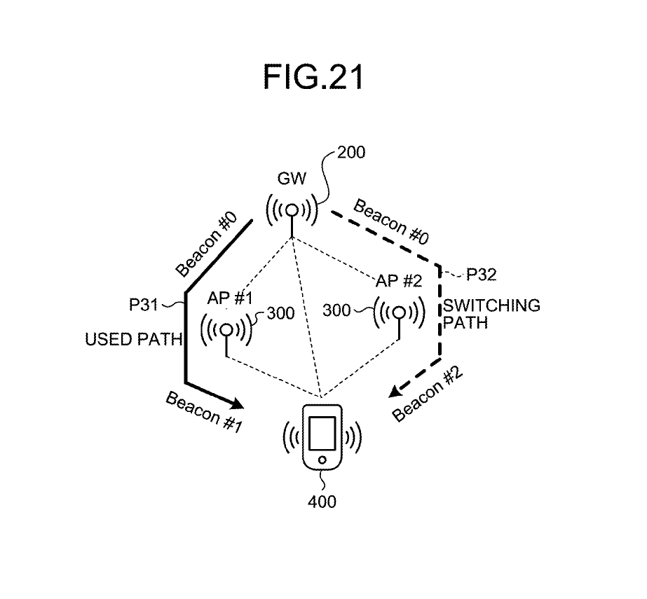

FIG. 21 is a diagram for explaining the issues arising in the wireless communication system according to a third embodiment. For example, in a path P31, the beacon information #0 (“Beacon #0” illustrated in FIG. 21) is sent from the GW 200 to the first AP 300 (“AP #1” illustrated in FIG. 21). Moreover, in the path P31, the beacon information #1 (“Beacon #1” illustrated in FIG. 21) is sent from the AP 300 identified as “AP #1” to the STA 400. In a path P32, the beacon information #0 is sent from the GW 200 to the second AP 300 (“AP #2” illustrated in FIG. 21), and beacon information #2 (“Beacon #2” illustrated in FIG. 21) is sent from the AP 300 identified as “AP #2” to the STA 400.

In this case, there arises an issue that it is difficult for the STA 400 to receive the beacon information #1 and the beacon information #2 sent from the two APs identified as “AP #1” and “AP #2” having the same node hop count. Herein, it is possible to think of a method in which different slots are used in all APs 300. However, when a large number of APs 300 are present, it results in deterioration of the traffic efficiency.

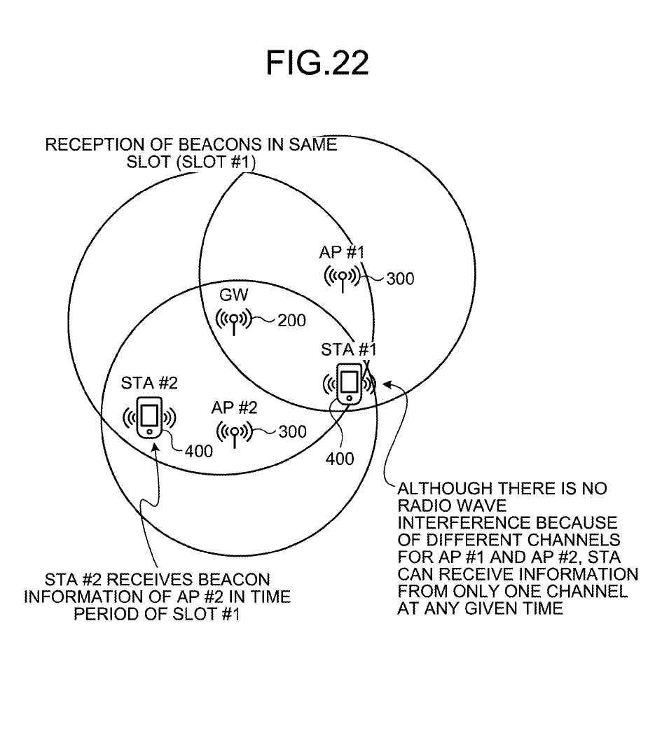

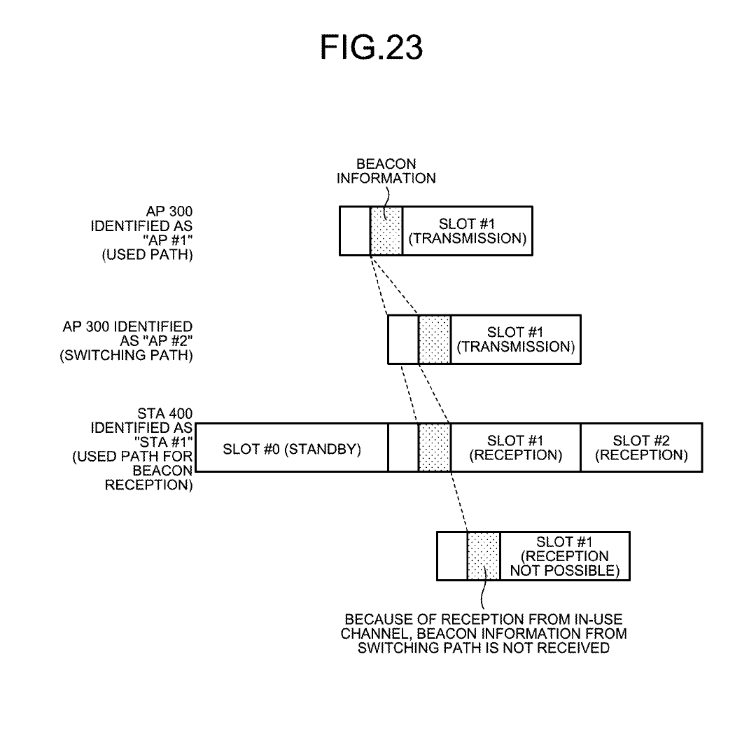

FIGS. 22 and 23 are diagrams for explaining the issues arising in the wireless communication system according to the third embodiment. For example, the beacon information #0 is sent from the GW 200 to the two APs 300 (identified as “AP #1” and “AP #2” illustrated in FIG. 22). At that time, the beacon information #1 is sent from the AP 300 identified as “AP #1” to the STA 400, and the beacon information #2 is sent from the AP 300 identified as “AP #2” to two STAs 400 (“STA #1” and “STA #2” illustrated in FIG. 22).

In this case, for example, it is possible to think of a method of shifting the position of the slot to which the beacon information #2 sent from the AP 300 (identified as “AP #2”) is assigned. However, there exists the STA 400 identified as “STA #2” that receives the beacon information in the time period of the slot “SLOT #1”. That is, as illustrated in FIG. 23, since the STA 400 identified as “STA #1” receives the beacon information in the in-use channel in the path P31, it is difficult for the STA 400 to receive the beacon information in the switching path (the path P32).

Solution

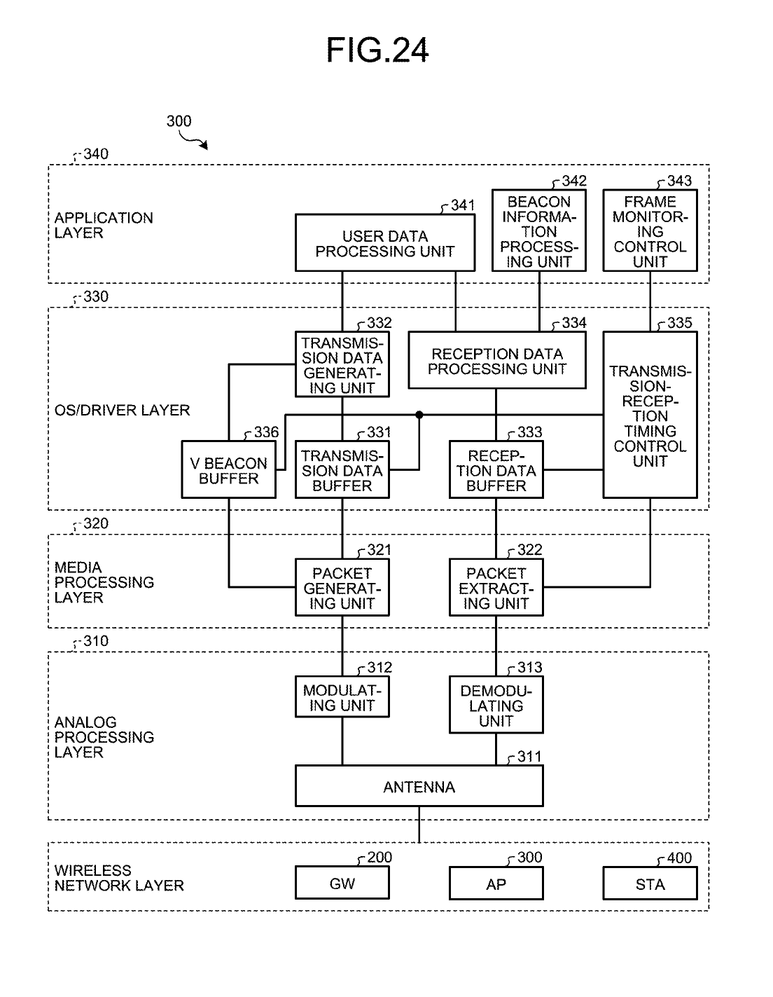

FIG. 24 is a block diagram illustrating an exemplary configuration of the AP 300 of the wireless communication system according to the third embodiment. In the AP 300 illustrated in FIG. 24, the OS/driver layer 330 further includes a V beacon buffer 336 meant for storing the beacon information.

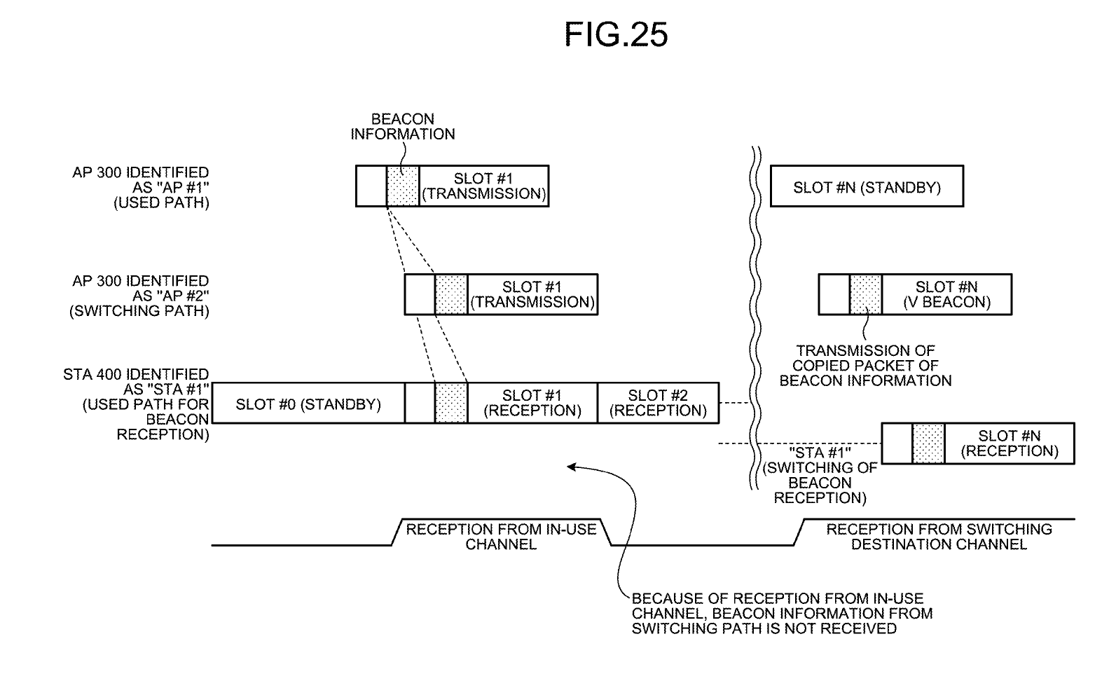

FIG. 25 is a diagram for explaining a solution to the issues arising in the wireless communication system according to the third embodiment. Herein, with respect to the AP 300 identified as “AP #2” and the STA 400 identified as “STA #1” in the path P32 among a plurality of paths P31 and P32 having the same node hop count, the server 100 specifies the slot in which the copied beacon information is to be assigned.

In this case, in the AP 300 identified as “AP #1” in the path P31, the transmission-reception timing control unit 335 of the OS/driver layer 330 assigns the beacon information in the slot “SLOT #1” at the position corresponding to the node hop count of one among a plurality of slots. Then, the transmission-reception timing control unit 335 of the OS/driver layer 330 sends that beacon information from the transmission data buffer 331 to the STA 400, which represents the neighboring node to the AP 300 identified as “AP #1”, via the media processing layer 320 and the analog processing layer 310. In the path P31, the STA 400 identified as “STA #1” receives the beacon information sent in the time period of the slot “SLOT #1” from the AP 300 identified as “AP #1”.

On the other hand, in the AP 300 identified as “AP #2” in the path P32, the transmission-reception timing control unit 335 of the OS/driver layer 330 copies the beacon information. Then, the transmission-reception timing control unit 335 assigns V beacon information (the copied beacon information) in the slot “SLOT #1” present at the position specified by the server 100. The transmission-reception timing control unit 335 sends the V beacon information from the V beacon buffer 336 to the STA 400, which represents the neighboring node to the AP 300 identified as “AP #2”, via the media processing layer 320 and the analog processing layer 310. In the path P32, the STA 400 identified as “STA #1” receives the V beacon information sent in the time period of the slot “SLOT #N” from the AP 300 identified as “AP #2”. With that, the abovementioned issues get resolved.

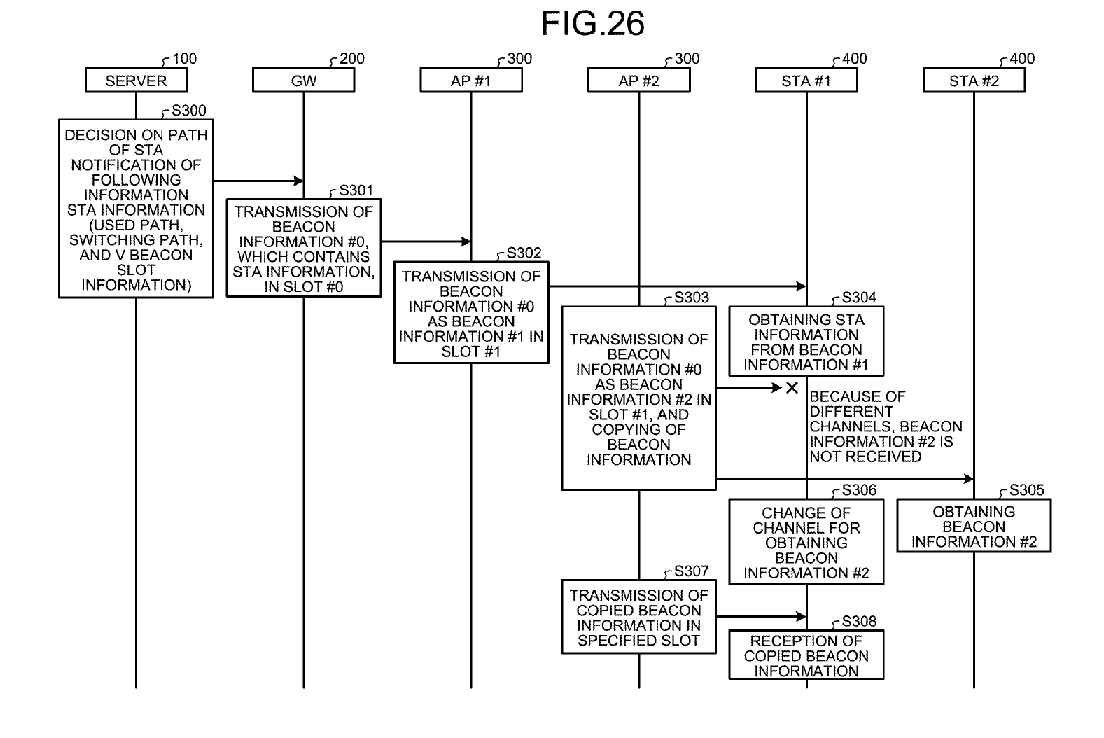

FIG. 26 is a sequence diagram illustrating an exemplary solution to the issues arising in the wireless communication system according to the third embodiment.

When the paths P31 and P32 of the STA 400 identified as “STA #1” are decided, the server 100 notifies the GW 200 about STA information containing the used path, the switching path, and the V beacon slot information (Step S300). Herein, the used path implies the path P31 and the switching path implies the path P32. The V beacon slot information represents information for specifying, in the path P32, the slot to which the V beacon information (the copied beacon information) is to be assigned.

The GW 200 receives the STA information from the server 100 and adds it to the beacon information #0. Then, the GW 200 sends the beacon information #0, which contains the STA information, in the time period of the slot “SLOT #0” (Step S301).

In the path P31, the AP 300 identified as “AP #1” receives the beacon information #0 sent from the GW 200 in the time period of the slot “SLOT #0”. Then, the AP 300 identified as “AP #1” assigns the beacon information #0 to the slot “SLOT #1” present at the position corresponding to the node hop count of one among a plurality of slots. Subsequently, the AP 300 identified as “AP #1” sends the beacon information #0 as the beacon information #1 in the time period of the slot “SLOT #1” (Step S302).

In the path P32, the AP 300 identified as “AP #2” receives the beacon information #0 sent from the GW 200 in the time period of the slot “SLOT #0”. Then, the AP 300 identified as “AP #2” assigns the beacon information #0 to the slot “SLOT #1” present at the position corresponding to the node hop count of one among a plurality of slots. Subsequently, the AP 300 identified as “AP #2” sends the beacon information #0 as the beacon information #2 in the time period of the slot “SLOT #1”. Moreover, the AP 300 identified as “AP #2” copies the beacon information #0 and stores it as V beacon information in a memory (not illustrated) (Step S303).

In the path P31, the STA 400 identified as “STA #1” receives the beacon information #1 that is sent in the time period of the slot “SLOT #1” from the AP 300 identified as “AP #1”. At that time, the STA 400 identified as “STA #1” obtains the STA information included in the beacon information #1 (Step S304).

In the path P32, the STA 400 identified as “STA #2” receives the beacon information #2 that is sent in the time period of the slot “SLOT #1” from the AP 300 identified as “AP #2” (Step S305).

Herein, in the path P31, it is difficult for the STA 400 to receive the beacon information #2, which is sent in the time slot of the slot “SLOT #1” from the AP 300 identified as “AP #2”, because the channels are different. In that regard, the STA 400 identified as “STA #1” changes the channel based on the obtained STA information (Step S306).

The AP 300 identified as “AP #2” assigns the V beacon information (the copied beacon information) to the slot “SLOT #N” present at the position specified by the server 100. Then, the AP 300 identified as “AP #2” sends the V beacon information (the copied beacon information) in the time period of the slot “SLOT #N” (Step S307).

The STA 400 identified as “STA #1” receives the V beacon information (the copied beacon information) in the time period of the slot “SLOT #N” from the AP 300 identified as “AP #2” (Step S308).

Effect

As described above, in the wireless communication system according to the third embodiment, there are times when a plurality of paths P31 and P32 having the same node hop count is present. In that regard, the notification information processing unit of a plurality of wireless communication devices (in this case, the APs 300) assigns, in the first path (the path P31), notification information (beacon information) to the slot present at the position corresponding to the node hop count. On the other hand, the notification information processing unit of a plurality of wireless communication devices (in this case, the APs 300) assigns, in the other path (the path P32) other than the first path (other the path P31); copies the beacon information; and assigns the copied beacon information to the slot present at the position specified by the server 100.

For example, when the AP 300 represents the wireless communication device, the notification information processing unit includes the analog processing layer, the media processing layer 320, the OS/driver layer 330, and the application layer 340. In this case, in the path P31, the notification information processing unit of the AP 300 identified as “AP #1” (for example, the transmission-reception timing control unit 335 of the OS/driver layer 330) assigns the beacon information to the slot “SLOT #1” present at the position corresponding to the node hop count of one among a plurality of slots. On the other hand, in the path P32, the notification information processing unit of the AP 300 identified as “AP #2” (for example, the transmission-reception timing control unit 335) assigns the copied beacon information to the slot “SLOT #N” present at the position specified by the server 100 among a plurality of slots.

In this way, in the wireless communication system according to the third embodiment, even when a plurality of paths P31 and P32 having the same node hop count is present, the STA 400 identified as “STA #1” can receive the beacon information from the APs 300 identified as “AP #1” and “AP #2”.

### [d] Fourth Embodiment

Correction of Transmission Start Position of Uplink Data of TDD Type

In order for the GW 200, the AP 300, and the STA 400 to receive uplink data in the time periods of the TDD type, the AP 300 and the STA 400 need to match the transmission start position of the uplink data of the TDD type. For example, the GW 200 measures the delay period when data is sent and received in the path from the GW 200 to the STA 400; and, based on the delay period, the STA 400 adjusts the timing for sending data using multihop communication of the TDD type. In the following explanation, measuring the delay period is written as delay measurement, and adjusting the timing based on the delay period is written as delay adjustment.

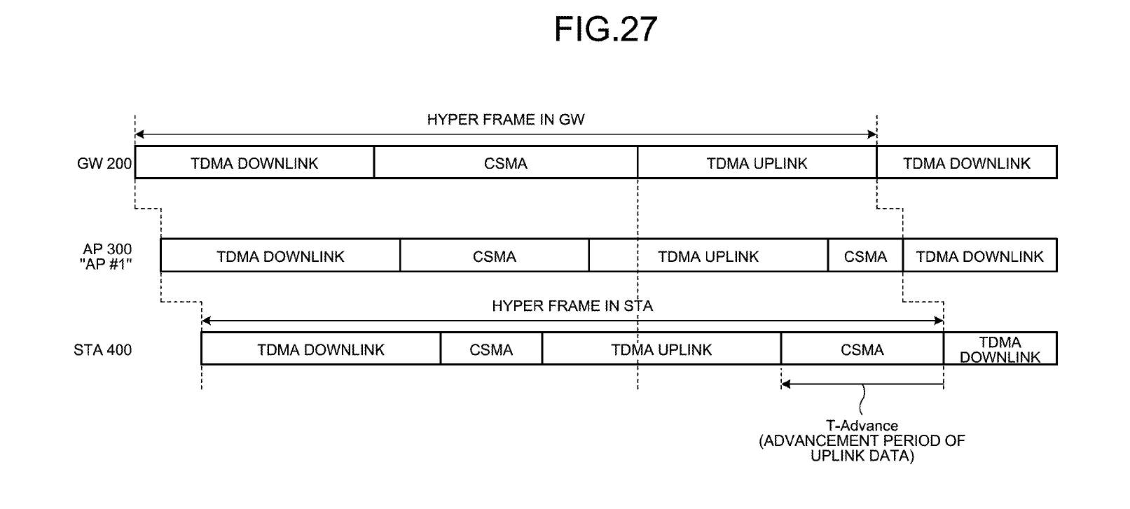

FIG. 27 is a conceptual diagram of delay measurement performed in the wireless communication system according to a fourth embodiment. For example, downlink data is transferred in the path from the GW 200 to the STA 400 via the AP 300 (“AP #1” illustrated in FIG. 27), and uplink data is transferred in the opposite path. As illustrated in FIG. 27, the advancement amount (the advancement period) is used for adjusting the timing of sending the data using multihop communication of the TDD type, and the time periods of the CSMA type are used for measuring the advancement amount. Upon receiving the beacon information, at the point of time of finalization of the frame position, the STA 400 issues a probe request (a connection request) to the GW 200 in the time periods of the CSMA type. In response to the probe request, the GW 200 sends back a probe response (a connection request response).

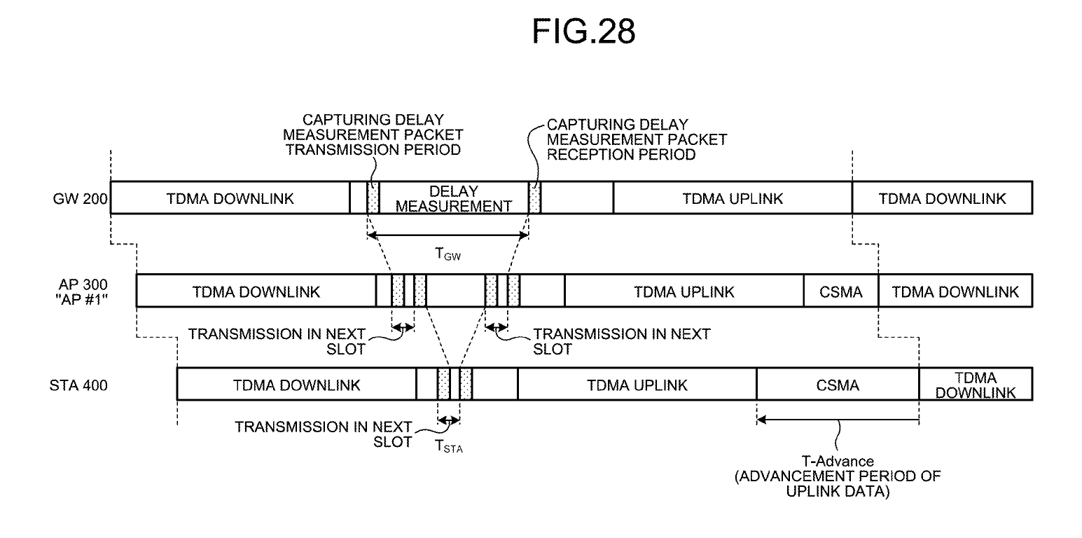

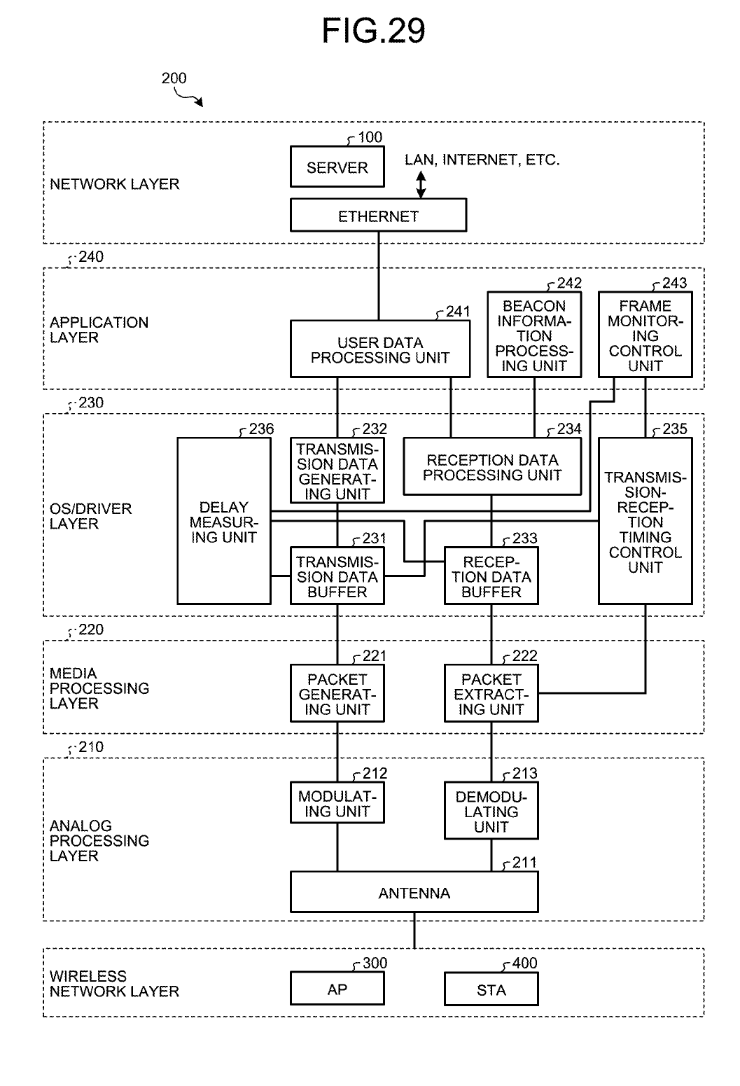

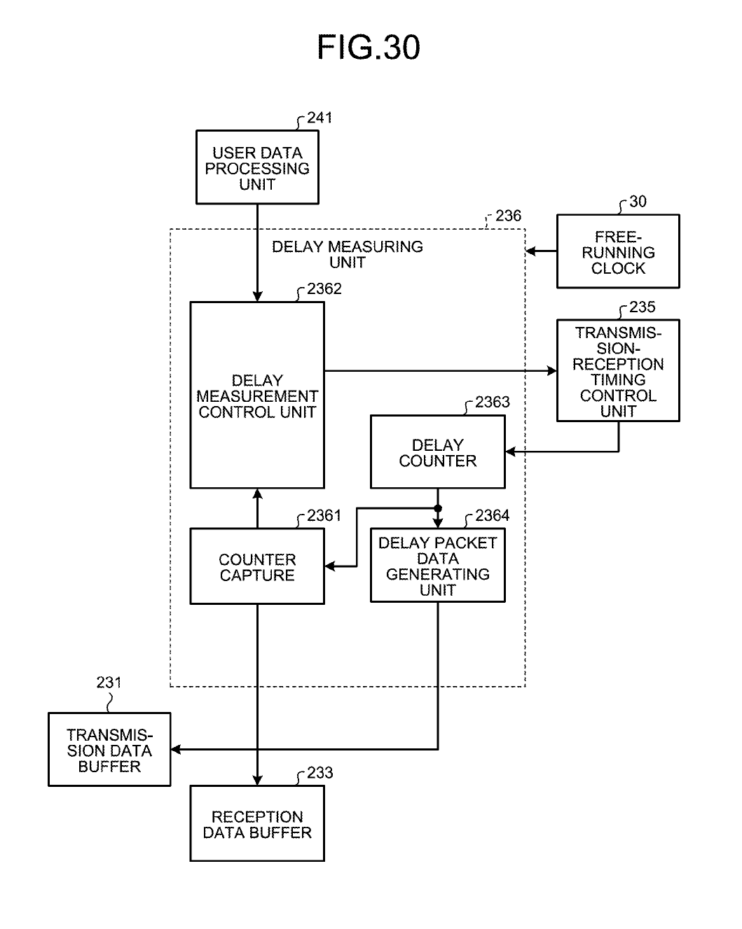

Given below is the explanation of a delay measurement packet. FIG. 28 is a conceptual diagram of the transfer of a delay measurement packet in the wireless communication system according to the fourth embodiment. FIG. 29 is a block diagram illustrating an exemplary configuration of the GW 200 in the wireless communication system according to the fourth embodiment. FIG. 30 is a block diagram illustrating an exemplary configuration of a delay measuring unit 236 of the GW 200 in the wireless communication system according to the fourth embodiment. In the GW 200 illustrated in FIG. 29, the OS/driver layer 230 includes the delay measuring unit 236 in addition to having the configuration illustrated in FIG. 5. The delay measuring unit 236 includes a counter capture 2361, a delay measurement control unit 2362, a delay counter 2363, and a delay packet data generating unit 2364.

The delay measurement control unit 2362 receives a delay measurement request and a delay measurement control timing from the user data processing unit 241, and notifies the transmission-reception timing control unit 235 about the delay measurement control timing. According to the delay measurement control timing, the transmission-reception timing control unit 235 issues a delay measurement start notification to the delay counter 2363. Then, the delay counter 2363 resets the counter value to zero, and at the same time issues a data transmission request to the delay packet data generating unit 2364. The delay packet data generating unit 2364 sends delay data to the transmission data buffer 231, so that a delay measurement packet gets sent from the GW 200. At that time, in the GW 200, the counter capture 2361 captures the transmission period of the delay measurement packet.

After sending the delay measurement packet, the GW 200 waits for the loop-back of the delay measurement packet. The delay measurement packet is sent from the GW 200 in the next slot to the AP 300 identified as “AP #1”, and is then sent from the AP 300 identified as “AP #1” in the next slot to the STA 400. Moreover, the delay measurement packet is sent from the STA 400 in the next slot to the AP 300 identified as “AP #1”, and is then sent from the AP 300 identified as “AP #1” in the next slot to the GW 200. In the GW 200, at the timing at which the reception data buffer 233 receives the delay measurement packet, the counter capture 2361 captures the reception period of the delay measurement packet. That is, the counter capture 2361 captures a delay counter value from the transmission timing of the delay measurement packet to the reception timing of the delay measurement packet. The delay counter value is sent from the GW 200 to the STA 400 via the AP 300 identified as “AP #1”.

The transmission-reception timing control unit 435 of the STA 400 (FIG. 7) calculates the advancement period of the uplink data based on the delay counter value. Herein, T_{GW} represents the delay counter value (the delay measurement packet delay period) in the GW 200; T_{STA} represents the transmission-reception delay period in the STA 400; and T-Advance represents the advancement period of uplink data. In this case, the advancement period T-advance of uplink data is calculated as follows.

T-Advance=T_{GW}−T_{STA}

The transmission-reception timing control unit 435 of the STA 400 (FIG. 7) uses the calculated advancement period T-Advance and adjusts the transmission timing of data reaching the GW 200 using multihop communication of the TDD type.

Issues

Generally, since each AP 300 and each STA 400 operates according to an asynchronous clock, the delay measurement value undergoes constant changes. Hence, the delay measurement as described above needs to be frequently performed during the operations too. At the time of performing the delay measurement, if the target path is being accessed from elsewhere too, then there occurs an unintended delay in the delay measurement packet, and thus to perform the delay measurement is difficult in an accurate way.

Solution

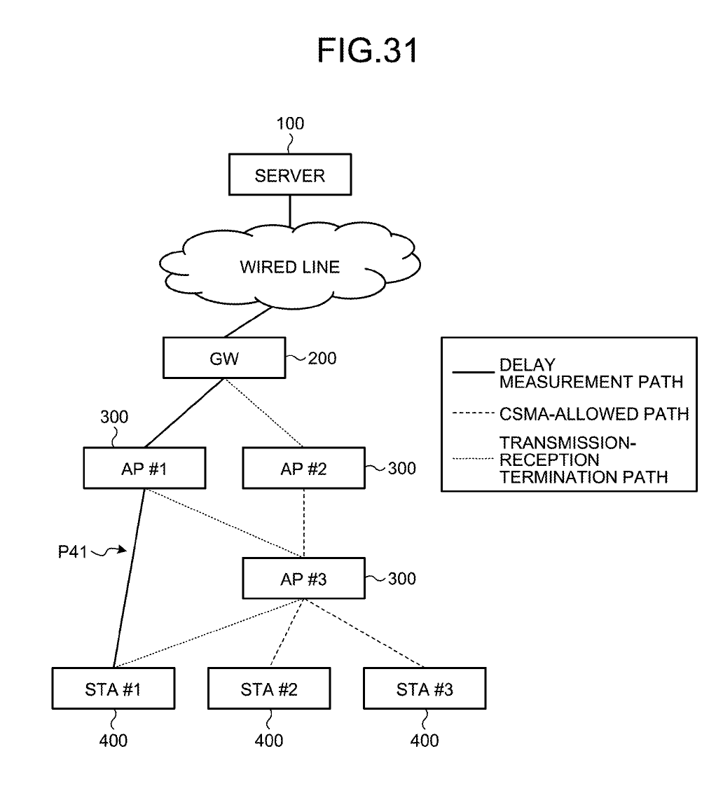

FIG. 31 is a diagram for explaining a solution to the issues arising in the wireless communication system according to the fourth embodiment. Herein, the server 100 sends, to the GW 200, delay measurement information (described later) containing a delay measurement path P41 from the GW 200 to the STA 400 identified as “STA #1” via the AP 300 identified as “AP #1”. For example, the delay measurement information (described later) is transferred from the GW 200 to the STA 400 identified as “STA #1” via the AP 300 identified “AP #1”, and is transferred from the GW 200 to the STAs 400 identified as “STA #2” and “STA #3” via the APs 300 identified “AP #2” and “AP #3”.

In this case, based on the delay measurement information (described later); the GW 200, the AP 300 identified as “AP #1”, and the STA 400 identified as “STA #1” that are present in the delay measurement path P41 transfer the delay measurement packet in the time periods of the CSMA type. Then, the GW 200 performs delay measurement for measuring the delay period between the transmission of the delay measurement packet and the reception thereof in the delay measurement path P41. The delay period is equivalent to the delay counter value (the delay measurement packet delay period) T_{GW} mentioned above. Based on the delay counter value (the delay measurement packet delay period) T_{GW} notified from the GW 200, the STA 400 identified as “STA #1” calculates the advancement period T-Advance meant for adjusting the timing of sending the uplink data using multihop communication of the TDD type. That is, the STA 400 identified as “STA #1” performs delay adjustment.

When delay measurement and delay adjustment is being performed, based on the delay measurement information (described later), the wireless communication devices not present in the delay measurement path P41 stop CSMA communication with the wireless communication devices present in the delay measurement path P41 (refer to “transmission-reception termination paths” illustrated using dotted lines in FIG. 31). For example, the AP 300 identified as “AP #2” represents a wireless communication device not present in the delay measurement path P41. In this case, based on the delay measurement information, the AP 300 identified as “AP #2” stops CSMA communication with the GW 200 present in the delay measurement path P41. Moreover, for example, the AP 300 identified as “AP #3” represents a wireless communication device not present in the delay measurement path P41. In this case, based on the delay measurement information, the AP 300 identified as “AP #3” stops the communication with the STA 400 identified as “STA #1”. With that, the abovementioned issues get resolved.

Herein, a wireless communication device not present in the delay measurement path P41 can perform CSMA communication with the other wireless communication devices not present in the delay measurement path P41 (refer to “CSMA-allowed paths” illustrated using dashed lines in FIG. 31). For example, when the AP 300 identified as “AP #2” represents a wireless communication device not present in the delay measurement path P41, it performs CSMA communication with the AP 300 identified as “AP #3”. For example, when the AP 300 identified as “AP #3” represents a wireless communication device not present in the delay measurement path P41, it performs CSMA communication with the STAs 400 identified as “STA #2” and “STA #3”.

In this way, the server 100 decides the delay measurement schedule of each path as the delay measurement information (described later); and notifies the GW 200, the APs 300, and the STAs 400 about the delay measurement information. The notification can include specification up to the hyper frame number, thereby enabling an advance notice of substantially few tens of seconds. The delay measurement path P41 that is set in the schedule (the delay measurement information) is treated as the path to be used in the actual measurement, and the paths not affecting the delay measurement (the paths other than the delay measurement path P41) are treated as the normal CSMA access paths. However, even in the paths other than the delay measurement path P41; the GW 200 and the APs 300 identified as “AP #2” and “AP #3” are not allowed to be accessed. Hence, the transmission-reception termination paths (refer to the dotted lines in FIG. 31) are set in the schedule (the delay measurement information). Then, the GW 200, the AP 300 identified as “AP #1”, and the STA 400 identified as “STA #1” present in the delay measurement path P41 transfer delay measurement packets based on the schedule (the delay measurement information); and the GW 200 performs delay measurement. The STA 400 identified as “STA #1” calculates the advancement period T-Advance based on the delay counter value (the delay measurement packet delay period) T_{GW} notified from the GW 200. Then, the STA 400 identified as “STA #1” performs delay adjustment using the advancement period T-Advance, and the APs 300 and the STAs 400 start the uplink access with the delay adjustment serving as the trigger.

The delay measurement is fundamentally performed in response to the receipt of a probe request (a connection request) issued by the GW 200. Moreover, during the operations too, the delay measurement can be performed at an arbitrary timing in response to a delay measurement request issued by the GW 200. In either case, the delay measurement is performed in response to a start request from the server 100.

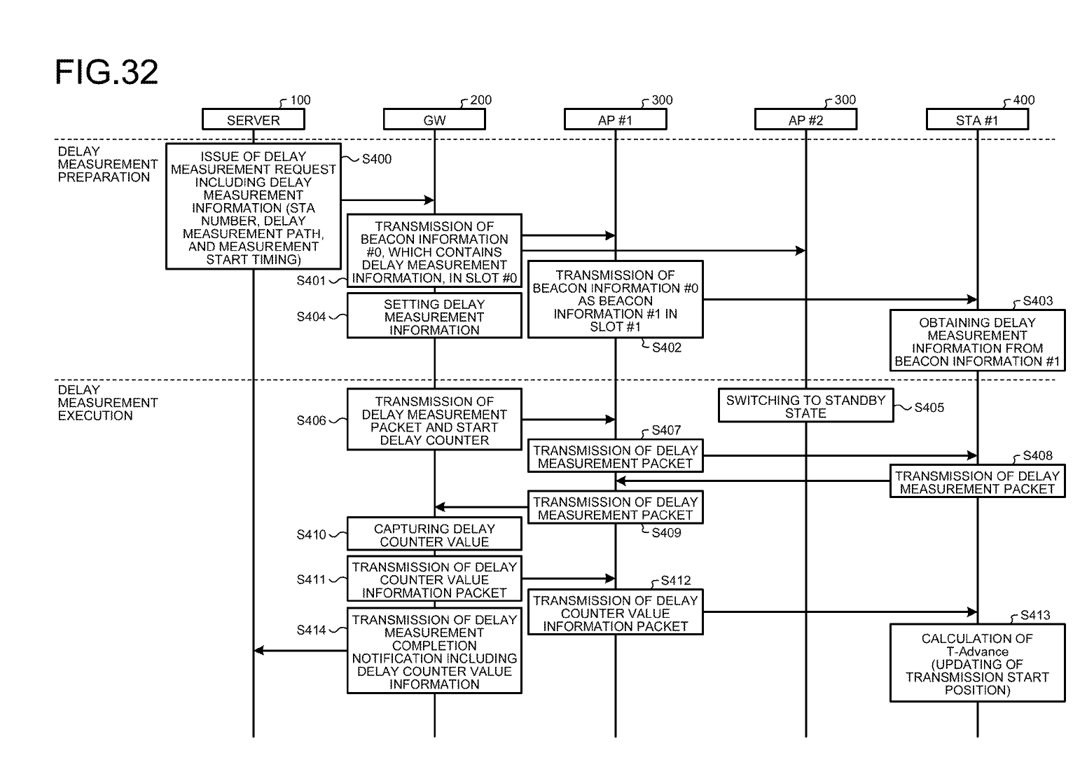

FIG. 32 is a sequence diagram illustrating an exemplary solution to the issues arising in the wireless communication system according to the fourth embodiment.

Firstly, in the wireless communication system according to the fourth embodiment, “delay measurement preparation” illustrated in FIG. 32 is performed in the time periods of the TDD type.

The server 100 generates the delay measurement information according to the schedule. The delay measurement information contains the STA number “STA #1” of the target STA 400, contains information about the delay measurement path P41, and contains the measurement start period at the time of performing the delay measurement in the time periods of the CSMA type. The information about the delay measurement path P41 contains the information about the transmission-reception termination paths (refer to the dotted lines illustrated in FIG. 31) and the information about the CSMA-allowed paths (refer to dashed lines illustrated in FIG. 31). Then, the server 100 issues a delay measurement request, which includes the delay measurement information, to the GW 200 (Step S400).

The GW 200 receives the delay measurement request from the server 100 and adds the delay measurement information, which is included in the delay measurement request, to the beacon information #0. Then, the GW 200 sends the beacon information #0, which contains the delay measurement information, in the time period of the slot “SLOT #0” (Step S401).

The AP 300 identified as “AP #1” and representing the neighboring node to the GW 200 receives the beacon information #0 that is sent from the GW 200 in the time period of the slot “SLOT #0” and that contains the delay measurement information. Herein, the AP 300 identified as “AP #1” obtains the delay measurement information and recognizes that it itself is present in the delay measurement path P41. Then, the AP 300 identified as “AP #1” sends the beacon information #0, which contains the delay measurement information, as the beacon information #1 in the time period of the slot “SLOT #1” (Step S402).

The STA 400 identified as “STA #1” and representing the neighboring node to the AP 300 identified as “AP #1” receives the beacon information #1 that is sent from the AP 300 identified as “AP #1” in the time period of the slot “SLOT #1” and that contains the delay measurement information. As a result of obtaining the delay measurement information, the STA 400 identified as “STA #1” recognizes that it itself is present in the delay measurement path P41 (Step S403).

The GW 200 sends the beacon information #0, which contains the delay measurement information, in the time period of the slot “SLOT #0”. At that time, the frame monitoring control unit 243 of the GW 200 sets the delay measurement information in the delay measuring unit 236 and the transmission-reception timing control unit 235 (Step S404). When the delay measurement information is set in the delay measuring unit 236 and the transmission-reception timing control unit 235, the GW 200 recognizes that the “delay measurement preparation” is complete.

Subsequently, in the wireless communication system according to the fourth embodiment, “delay measurement execution” illustrated in FIG. 32 is performed in the time periods of the CSMA type specified in the “delay measurement preparation”.

The AP 300 identified as “AP #2” and representing the neighboring node to the GW 200 receives the beacon information #0 that is sent from the GW 200 in the time period of the slot “SLOT #0” and that contains the delay measurement information. As a result of obtaining the delay measurement information, the AP 300 identified as “AP #2” recognizes that it itself is not present in the delay measurement path P41. In this case, the AP 300 identified as “AP #2” switches to the standby state (Step S405). That is, the AP 300 identified as “AP #2” stops the CSMA communication with the GW 200 that is present in the delay measurement path P41. Meanwhile, the AP 300 identified as “AP #2” can perform CSMA communication with the AP 300 identified as “AP #3”. In an identical manner, the AP 300 identified as “AP #3”, the STA 400 identified as “STA #2”, and the STA 400 identified as “STA #3” switch to the standby state.

The transmission-reception timing control unit 235 of the GW 200, which is present in the delay measurement path P41, issues a delay measurement start trigger to the delay measuring unit 236 at the measurement start timing. Upon receiving the delay measurement start trigger, the delay measuring unit 236 resets the counter value of the delay counter 2363 to zero, and at the same time sends delay data to the transmission data buffer 231, so that the delay measurement packet gets sent from the GW 200. That is, the GW 200 present in delay measurement path P41 sends the delay measurement packet to the AP 300 identified as “AP #1” and present in the delay measurement path P41. At that time, in the GW 200, the counter capture 2361 captures the transmission period of the delay measurement packet. That is, the counter capture 2361 starts counting the delay counter value (the delay measurement packet delay period) T_{GW} (Step S406). Herein, the contents of the delay measurement packet are not particularly defined.

The AP 300 identified as “AP #1” and present in the delay measurement path P41 receives the delay measurement packet from the GW 200 and sends it in the next slot to the STA 400 identified as “STA #1” and present in the delay measurement path P41 (Step S407).

The STA 400 identified as “STA #1” and present in the delay measurement path P41 receives the delay measurement packet from the AP 300 identified as “AP #1”, and sends it in the next slot to the STA 300 identified as “STA #1” and present in the delay measurement path P41 (Step S408).

The AP 300 identified as “AP #1” and present in the delay measurement path P41 sends the delay measurement packet in the next slot to the GW 200 present in the delay measurement path P41 (Step S409).

In the GW 200 present in the delay measurement path P41, at the timing at which the reception data buffer 233 receives the delay measurement packet, the counter capture 2361 captures the reception period of the delay measurement packet. That is, the counter capture 2361 captures the delay counter value (the delay measurement packet delay period) T_{GW} from the transmission timing to the reception timing of the delay measurement packet (Step S410).

The GW 200 present in the delay measurement path P41 sends, as the delay counter value information packet, the packet including the information about the delay counter value T_{GW} to the AP 300 identified as “AP #1” and present in the delay measurement path P41 (Step S411).

The AP 300 identified as “AP #1” and present in the delay measurement path P41 receives the delay counter value information packet from the GW 200, and sends it in the next slot to the STA 400 identified as “STA #1” and present in the delay measurement path P41 (Step S412).

The STA 400 identified as “STA #1” and present in the delay measurement path P41 receives the delay counter value information packet from the AP 300 identified as “AP #1”. Based on the delay counter value T_{GW} included in the delay counter value information packet, the transmission-reception timing control unit 435 of the STA 400 identified as “STA #1” calculates the advancement period T-Advance of the uplink data. Then, based on the calculated advancement period T-Advance, the transmission-reception timing control unit 435 updates the transmission start position of the uplink data of the TDD technology (Step S413).

Meanwhile, after sending the delay counter value information packet to the AP 300 identified as “AP #1” and present in the delay measurement path P41, the GW 200 present in the delay measurement path P41 sends a delay measurement completion notification including the information about the delay counter value T_{GW} to the server 100 (Step S414). When the delay measurement completion notification is received from the GW 200, the server 100 recognizes that the “delay measurement execution” is complete.

Effect

As described above, in the wireless communication system according to the fourth embodiment, the server 100 sends the delay measurement information that contains the delay measurement path P41 from a first wireless communication device (in this case, the GW 200) to a second wireless communication device (in this case, the STA 400 identified as “STA #1”) among a plurality of wireless communication devices (the GW 200, the APs 300, and the STAs 400). In each wireless communication device present in the delay measurement path P41 (in this case, the GW 200, the AP 300 identified as “AP #1”, and the STA 400 identified as “STA #1”), the notification information processing unit transfers packets in the time periods of the CSMA type based on the delay measurement information.

For example, when the GW 200 represents the wireless communication device, the notification information processing unit includes the analog processing layer 210, the media processing layer 220, the OS/driver layer 230, and the application layer 240. Alternatively, for example, when the AP 300 represents the wireless communication device, the notification information processing unit includes the analog processing layer 310, the media processing layer 320, the OS/driver layer 330, and the application layer 340. Still alternatively, for example, when the STA 400 represents the wireless communication device, the notification information processing unit includes the analog processing layer 410, the media processing layer 420, the OS/driver layer 430, and the application layer 440. For example, with reference to FIG. 31, when the GW 200 represents the wireless communication device and when the notification information processing unit thereof receives the delay measurement information from the server 100, the notification information processing unit transfers the delay measurement information to the AP 300 identified as “AP #1”. For example, with reference to FIG. 31, when the AP 300 identified as “AP #1” represents the wireless communication device and when the notification information processing unit thereof receives the delay measurement information from the GW 200, the notification information processing unit transfers the delay measurement information to the STA 400 identified as “STA #1”.

Then, the notification information processing unit of the GW 200 (in this case, the delay measuring unit 236) performs delay measurement for measuring the delay period (the delay counter value Tₐd from the transmission of packets to the reception thereof in the delay measurement path P41. Based on the delay period (the delay counter value Tₐd notified from the GW 200, the notification information processing unit of the STA 400 identified as “STA #1” calculates the advancement period T-advance meant for adjusting the timing of sending data of the TDD type. That is, the STA 400 identified as “STA #1” performs delay adjustment.

While the delay measurement and the delay adjustment is being performed, the communication processing unit of the wireless communication devices not present in the delay measurement path P41 stop the CSMA communication with the wireless communication devices present in the delay measurement path P41 based on the delay measurement information. For example, when the AP 300 represents the wireless communication device not present in the delay measurement path P41, the notification information processing unit includes the analog processing layer 310, the media processing layer 320, the OS/driver layer 330, and the application layer 340. For example, when the AP 300 identified as “AP #2” represents the wireless communication device not present in the delay measurement path P41, the AP 300 identified as “AP #2” stops the CSMA communication with the GW 200, which is present in the delay measurement path P41, based on the delay measurement information. For example, when the AP 300 identified as “AP #3” represents the wireless communication device not present in the delay measurement path P41, the AP 300 identified as “AP #3” stops the CSMA communication with the AP 300 identified as “AP #1” and with the STA 400 identified as “STA #1” based on the delay measurement information.

In this way, in the wireless communication system according to the fourth embodiment, when the GW 200 performs delay measurement in the delay measurement path P41, the wireless communication devices not present in the delay measurement path P41 stop the CSMA communication with the wireless communication devices present in the delay measurement path P41. As a result, in the wireless communication system according to the fourth embodiment, the GW 200 can perform delay measurement in an accurate way.

### [e] Fifth Embodiment

Issues

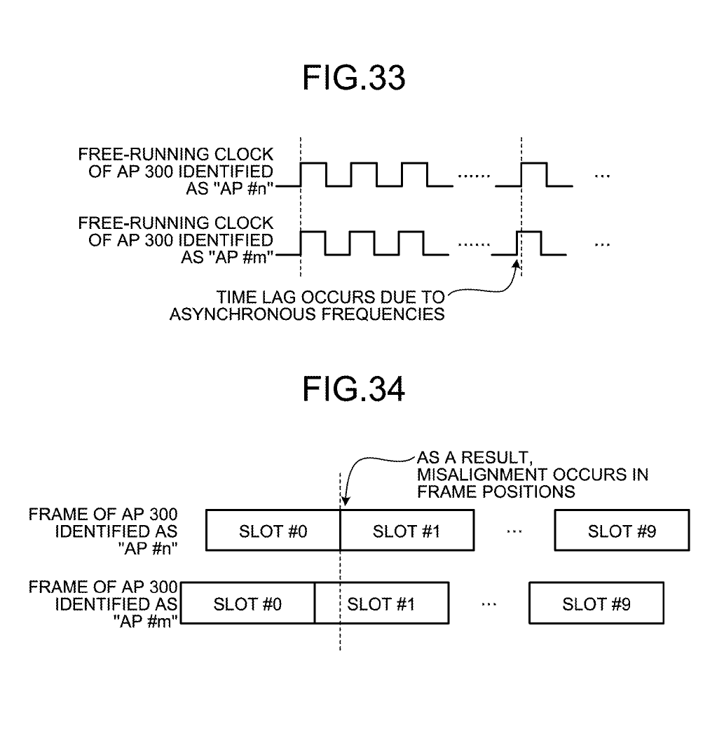

FIGS. 33 to 36 are diagrams for explaining the issues arising in the wireless communication system according to a fifth embodiment. As illustrated in FIG. 33, each AP 300 fundamentally operates according to a free-running clock included therein (for example, refer to the free-running clock 30 illustrated in FIG. 9). Hence, for example, between the AP 300 identified as “AP #n” and the AP 300 identified as “AP #m”, the frequency (in this case, the clock) becomes asynchronous. For that reason, there occurs a time lag between the AP 300 identified as “AP #n” and the AP 300 identified as “AP #m”. As a result, as illustrated in FIG. 34, between the AP 300 identified as “AP #n” and the AP 300 identified as “AP #m”, the slot positions become misaligned. That is, there occurs misalignment in the frame positions. In order to correct such misalignment, the delay adjustment needs to be frequently performed in the time periods of the CSMA type. However, if the delay adjustment is frequently performed, the system happens to have low frequency usage efficiency.

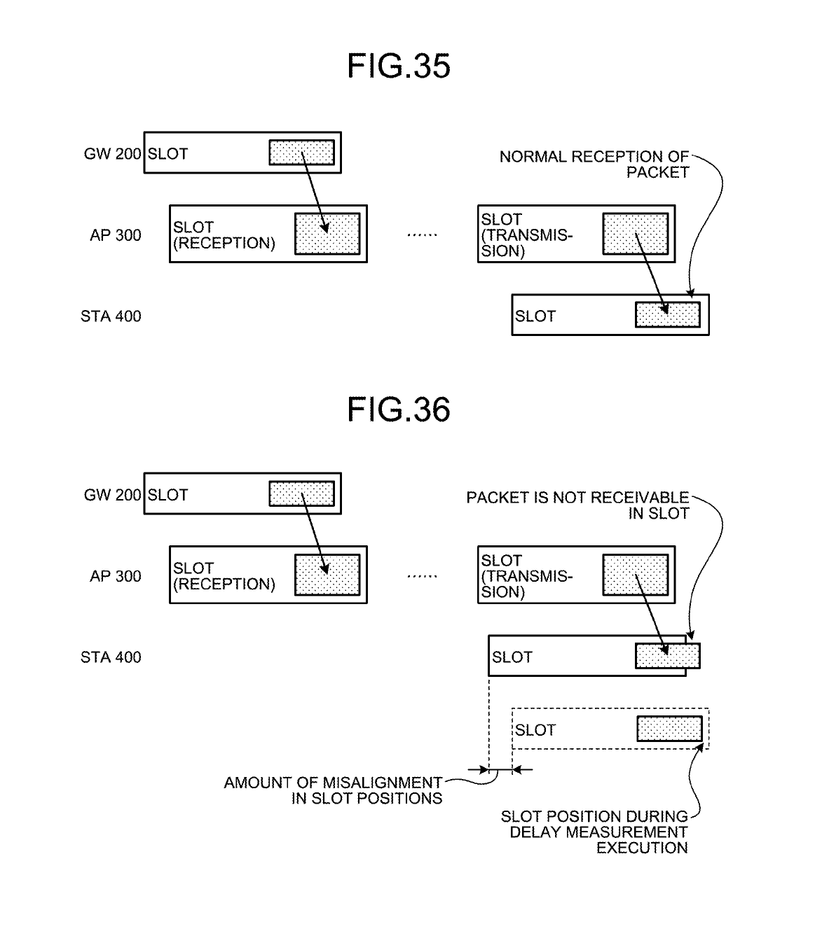

For example, as illustrated in FIG. 35, the AP 300 receives the data (packets) sent from the GW 200, and then sends the packets in the specified slot position to the STA 400. When there is no misalignment in the slot positions due to asynchrony, the STA 400 can normally receive the packets sent from the AP 300 in the specified slot. However, as illustrated in FIG. 36, when there is misalignment in the slot positions between the AP 300 and the STA 400, it is difficult for the STA 400 to normally receive the packets sent from the AP 300 in the specified slot.

Solution 1

Solution 1-1

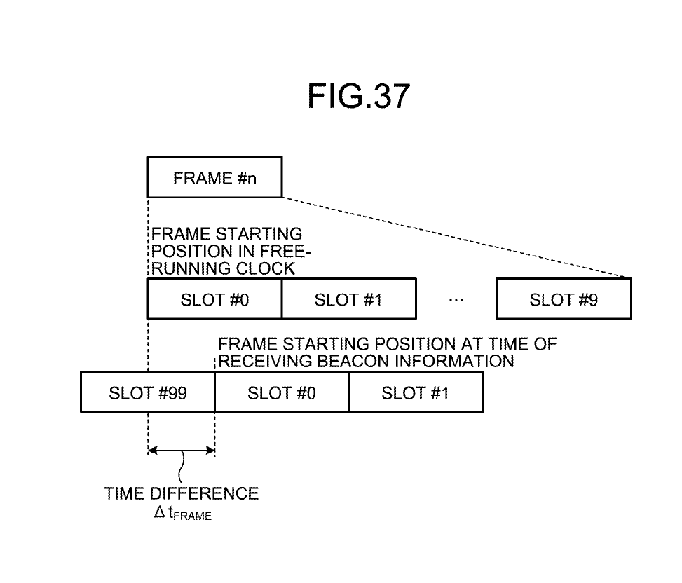

FIG. 37 is a diagram for explaining a solution 1-1 with respect to the issues arising in the wireless communication system according to the fifth embodiment.

At the time of booting, each wireless communication device (the GW 200, the APs 300, and the STAs 400) compares the starting position “SLOT #0” of the frame “FRAME #n” in the free-running clock with the starting position “SLOT #0” of the frame at the time of receiving beacon information. More particularly, the wireless communication device (for example, the STA 400 identified as “STA #1”) detects a time difference Δt_{FRAME} between the starting position “SLOT #0” of the frame “FRAME #n” in the free-running clock and the starting position “SLOT #0” of the frame at the time of receiving beacon information. Then, the wireless communication device (the STA 400 identified as “STA #1”) determines whether or not the time difference Δt_{FRAME} is equal to or greater than a threshold value.

If the time difference Δt_{FRAME} is equal to or greater than the threshold value, then the wireless communication device (in this case, the STA 400 identified as “STA #1”) issues a resynchronization request to the server 100. In response to the resynchronization request, the server 100 sends delay measurement information as a resynchronization instruction. Using the delay measurement information, the wireless communication devices present in the delay measurement path P41 (in this case, the GW 200, the AP 300 identified as “AP #1”, and the STA 400 identified as “STA #1”) are specified; and delay measurement and delay adjustment is performed. Based on the delay measurement and the delay adjustment, each wireless communication device present in the delay measurement path P41 (i.e., the GW 200, the AP 300 identified as “AP #1”, and the STA 400 identified as “STA #1”) synchronizes the corresponding frame “FRAME #n” in the free-running clock to the frame at the time of receiving beacon information. With that, the abovementioned issues get resolved.

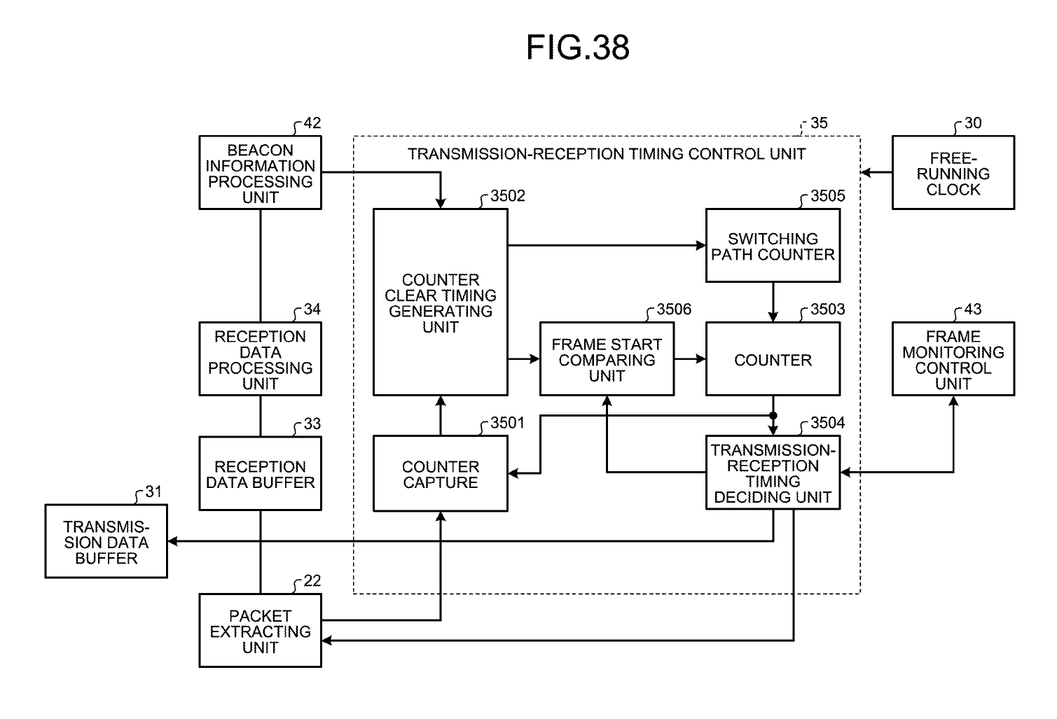

FIG. 38 is a block diagram illustrating an exemplary configuration of the transmission-reception timing control unit 35 of the GW 200, the APs 300, and the STAs 400 in the wireless communication system according to the fifth embodiment. The transmission-reception timing control unit 35 includes a frame start comparing unit 3506 in addition to having the configuration illustrated in FIG. 9 or FIG. 10.

The transmission-reception timing control unit 35 monitors the time difference Δt_{FRAME}. That is, the frame start comparing unit 3506 of the transmission-reception timing control unit 35 obtains, as the starting position “SLOT #0” of the frame at the time of receiving beacon information, the starting position “SLOT #0” of the frame obtained from the counter clear timing generating unit 3502. Moreover, the frame start comparing unit 3506 obtains, as the start position “SLOT #0” of the frame “FRAME #n” in the free-running clock 30, the starting position “SLOT #0” of the frame generated by the transmission-reception timing deciding unit 3504 using the counter value. Then, the frame start comparing unit 3506 compares the start position “SLOT #0” of the frame “FRAME #n” in the free-running clock and the starting position “SLOT #0” of the frame at the time of receiving beacon information. If the result of comparison indicates that the time difference Δt_{FRAME} is equal to or greater than the threshold value, then the frame start comparing unit 3506 notifies the frame monitoring control unit 43 about the same via the transmission-reception timing deciding unit 3504. In this case, the frame monitoring control unit 43 issues a frame resynchronization request to the server 100; and the resynchronization request is output from the transmission data buffer 31 via the transmission-reception timing deciding unit 3504.

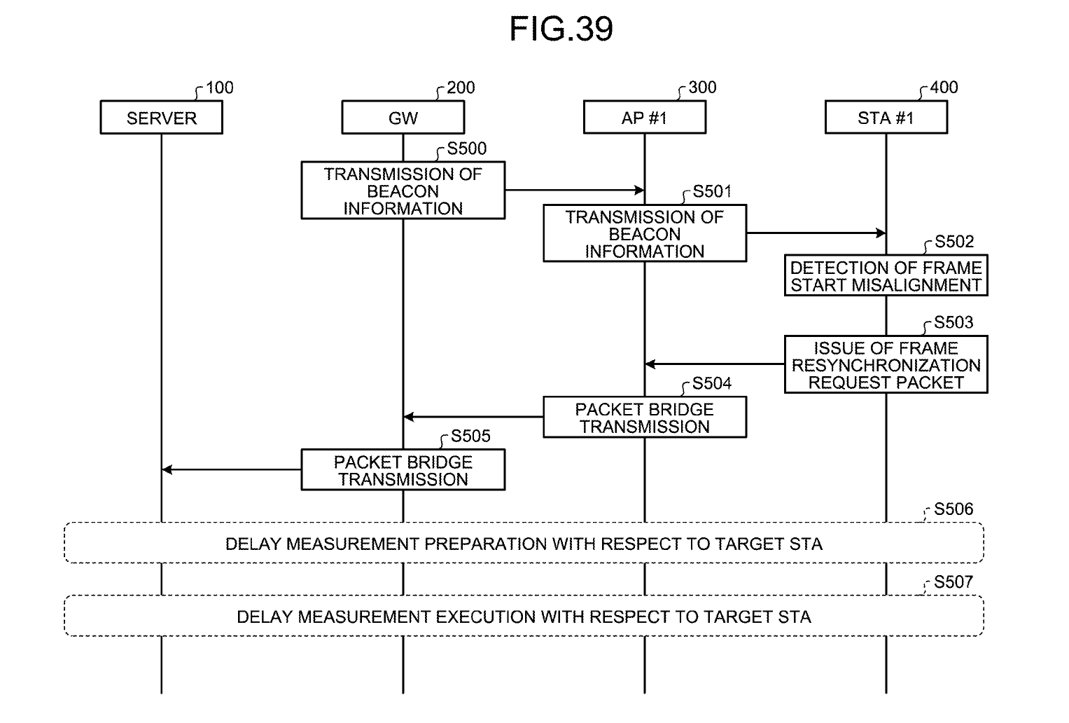

FIG. 39 is a sequence diagram illustrating an exemplary solution 1-1 with respect to the issues arising in the wireless communication system according to the fifth embodiment. With reference to FIG. 39, the explanation is given for the case in which the STA 400 identified as “STA #1” detects the time difference Δt_{FRAME} between the starting position “SLOT #0” of the frame “FRAME #n” in the free-running clock 30 and the starting position “SLOT #0” of the frame at the time of receiving beacon information.

For example, in the time periods of the TDD type, the GW 200 sends beacon information (Step S500).

The AP 300 identified as “AP #1” and representing the neighboring node to the GW 200 receives the beacon information sent from the GW 200, and then sends the beacon information (Step S501).

The STA 400 identified as “STA #1” and representing the neighboring node to the AP 300 identified as “AP #1” receives the beacon information sent from the AP 300 identified as “AP #1”. Then, the STA 400 identified as “STA #1” detects the time difference Δt_{FRAME} between the starting position “SLOT #0” of the frame “FRAME #n” in the free-running clock 30 and the starting position “SLOT #0” of the frame at the time of receiving beacon information. That is, according to the time difference Δt_{FRAME}, the STA 400 identified as “STA #1” detects the misalignment in the starting positions of the frames (Step S502).

If the time difference Δt_{FRAME} is equal to or greater than the threshold value, then the STA 400 identified as “STA #1” issues a frame resynchronization request packet as a resynchronization request, and then sends the frame resynchronization request packet (Step S503).

The AP 300 identified as “AP #1” and representing the neighboring node to the STA 400 identified as “STA #1” performs packet bridge transmission with respect to the frame resynchronization packet sent from the STA 400 identified as “STA #1”. That is, the AP 300 identified as “AP #1” receives the frame resynchronization request packet sent from the STA 400 identified as “STA #1”, and sends the frame resynchronization request packet (Step S504).

The GW 200 representing the neighboring node to the AP 300 identified as “AP #1” performs packet bridge transmission with respect to the frame resynchronization packet sent from the AP 300 identified as “AP #1”. That is, the GW 200 receives the frame resynchronization request packet sent from the AP 300 identified as “AP #1”, and then sends the frame resynchronization request packet to the server 100 (Step S505).

The server 100 receives the frame resynchronization request packet sent from the GW 200. At that time, in the time periods of the TDD type, delay measurement preparation is performed with respect to the target STA (in this case, the STA 400 identified as “STA #1” (Step S506). Then, in the time periods of the CSMA type, delay measurement execution is performed with respect to the target STA (in this case, the STA 400 identified as “STA #1” (Step S507). Herein, delay measurement preparation (Step S506) is equivalent to “delay measurement preparation” illustrated in FIG. 32, and delay measurement execution (Step S507) is equivalent to “delay measurement execution” illustrated in FIG. 32.

Solution 1-2

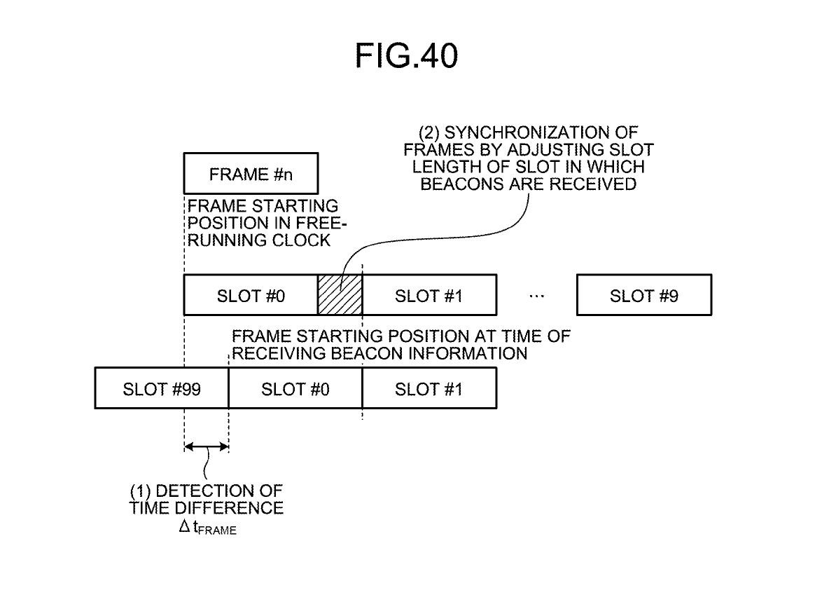

FIG. 40 is a diagram for explaining a solution 1-2 with respect to the issues arising in the wireless communication system according to the fifth embodiment.

At the time of booting, each wireless communication device (the GW 200, the APs 300, and the STAs 400) compares the starting position “SLOT #0” of the frame “FRAME #n” in the free-running clock 30 with the starting position “SLOT #0” of the frame at the time of receiving beacon information. More particularly, the wireless communication device (for example, the STA 400 identified as “STA #1”) detects the time difference Δt_{FRAME} between the starting position “SLOT #0” of the frame “FRAME #n” in the free-running clock 30 and the starting position “SLOT #0” of the frame at the time of receiving beacon information. Then, the wireless communication device (the STA 400 identified as “STA #1”) determines whether or not the time difference Δt_{FRAME} is equal to or greater than a threshold value.

If the time difference Δt_{FRAME} is equal to or greater than the threshold value, then the wireless communication device (in this case, the STA 400 identified as “STA #1”) adjusts the slot length of the starting position “SLOT #0” of the frame “FRAME #n” in the free-running clock 30 based on the time difference Δt_{FRAME}. With that, the wireless communication device (the STA 400 identified as “STA #1”) synchronizes the frame “FRAME #n” in the free-running clock 30 to the frame at the time of receiving beacon information. That is, based on the time difference Δt_{FRAME}, the frame start comparing unit 3506 of the wireless communication device (STA 400 identified as “STA #1”) autonomously clears the counter value of the counter 3503 illustrated in FIG. 38, and synchronizes the frames. With that, the abovementioned issues get resolved.

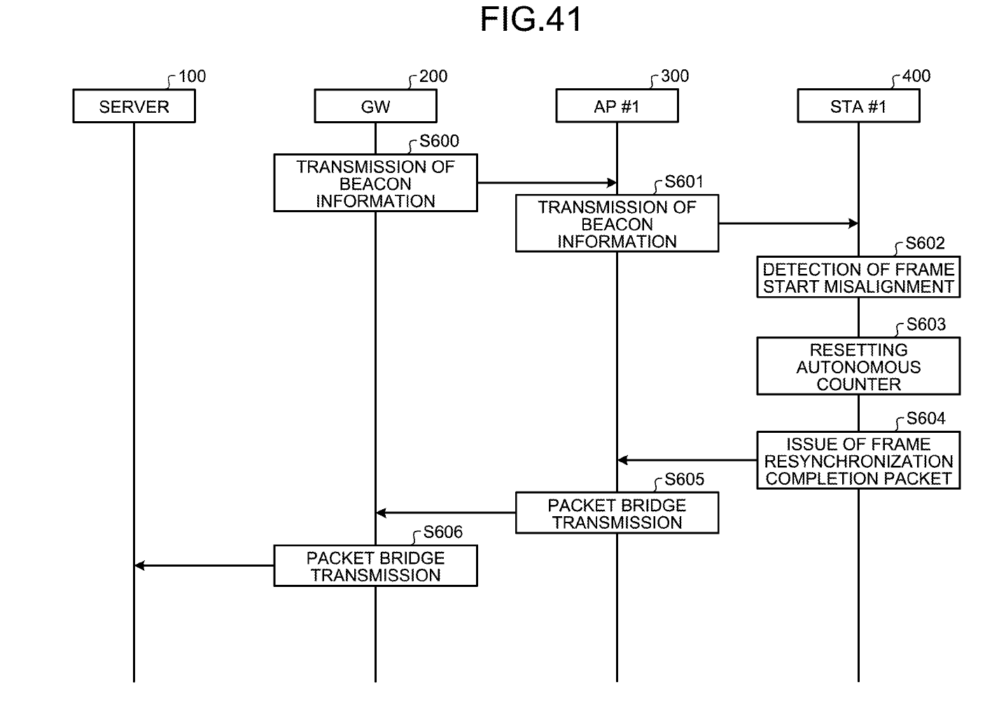

FIG. 41 is a sequence diagram illustrating an exemplary solution 1-2 with respect to the issues arising in the wireless communication system according to the fifth embodiment. With reference to FIG. 41, the explanation is given for the case in which the STA 400 identified as “STA #1” detects the time difference Δt_{FRAME} between the starting position “SLOT #0” of the frame “FRAME #n” in the free-running clock 30 and the starting position “SLOT #0” of the frame at the time of receiving beacon information.

For example, in the time periods of the TDD type, the GW 200 sends beacon information (Step S600).

The AP 300 identified as “AP #1” and representing the neighboring node to the GW 200 receives the beacon information sent from the GW 200, and then sends the beacon information (Step S601).

The STA 400 identified as “STA #1” and representing the neighboring node to the AP 300 identified as “AP #1” receives the beacon information sent from the AP 300 identified as “AP #1”. Then, the STA 400 identified as “STA #1” detects the time difference Δt_{FRAME} between the starting position “SLOT #0” of the frame “FRAME #n” in the free-running clock 30 and the starting position “SLOT #0” of the frame at the time of receiving beacon information. That is, according to the time difference Δt_{FRAME}, the STA 400 identified as “STA #1” detects the misalignment in the starting positions of the frames (Step S602).

If the time difference Δt_{FRAME} is equal to or greater than the threshold value, then the STA 400 identified as “STA #1” adjusts, based on the time difference Δt_{FRAME}, the slot length of the starting position “SLOT #0” of the frame “FRAME #n” in the free-running clock 30. In this case, based on the time difference Δt_{FRAME}, the STA 400 identified as “STA #1” autonomously clears the counter value of the counter 3503 illustrated in FIG. 38, and synchronizes the frames (Step S603). As a result, the STA device identified as “STA #1” synchronizes the frame “FRAME #n” in the free-running clock 30 to the frame at the time of receiving beacon information.

The STA 400 identified as “STA #1” issues a frame resynchronization completion packet indicating that the frames have been synchronized, and sends the frame resynchronization completion packet (Step S604).

The AP 300 identified as “AP #1” and representing the neighboring node to the STA 400 identified as “STA #1” performs packet bridge transmission with respect to the frame resynchronization completion packet. That is, the AP 300 identified as “AP #1” receives the frame resynchronization completion packet sent from the STA 400 identified as “STA #1”, and then sends the frame resynchronization completion packet (Step S605).

The GW 200 representing the neighboring node to the AP 300 identified as “AP #1” performs packet bridge transmission with respect to the frame resynchronization completion packet sent from the AP 300 identified as “AP #1”. That is, the GW 200 receives the frame resynchronization completion packet from the AP 300 identified as “AP #1”, and sends it to the server 100 (Step S606).

Meanwhile, in the solution 1-2 in which frame resynchronization is autonomously performed, the resynchronization period is shorter as compared to the solution 1-1 in which frame resynchronization is systemically performed. On the other hand, in the solution 1-2, there is a possibility that autonomous frame resynchronization occurs chronically in the wireless communication devices (the GW 200, the APs 300, and the STAs 400) thereby likely causing deterioration in the network performance. Hence, it is desirable to implement the solution 1-1.

Solution 2

The wireless communication devices (the GW 200, the APs 300, and the STAs 400) monitor whether or not data can be normally received from the specified slots.

When to receive the packets (data) from the specified slot normally is difficult, the wireless communication devices (the GW 200, the APs 300, and the STAs 400) notify the server 100 about a resynchronization request indicating that the packets are not normally received. In response to the resynchronization request, the server 100 sends delay measurement information as a resynchronization instruction. Using the delay measurement information, the wireless communication devices present in the delay measurement path P41 (in this case, the GW 200, the AP 300 identified as “AP #1”, and the STA 400 identified as “STA #1”) are specified; and delay measurement and delay adjustment is performed. Based on the delay measurement and the delay adjustment, each wireless communication device present in the delay measurement path P41 (i.e., the GW 200, the AP 300 identified as “AP #1”, and the STA 400 identified as “STA #1”) synchronizes the corresponding frame “FRAME #n” in the free-running clock to the frame at the time of receiving beacon information. With that, the abovementioned issues get resolved.

The transmission-reception timing control unit 35 illustrated in FIG. 38 monitors the specified slot. The transmission-reception timing deciding unit 3504 notifies the packet extracting unit 22 about reception period end information at the end of the reception period. At that time, if it is detected that the packet extracting unit 22 is still receiving data, then the transmission-reception timing deciding unit 3504 issues an out-of-reception-range error notification to the frame monitoring control unit 43, and destroys the reception packets. At the same time, the frame monitoring control unit 43 issues a frame resynchronization request to the server 100; and the resynchronization request is output from the transmission data buffer 31 via the transmission-reception timing deciding unit 3504.

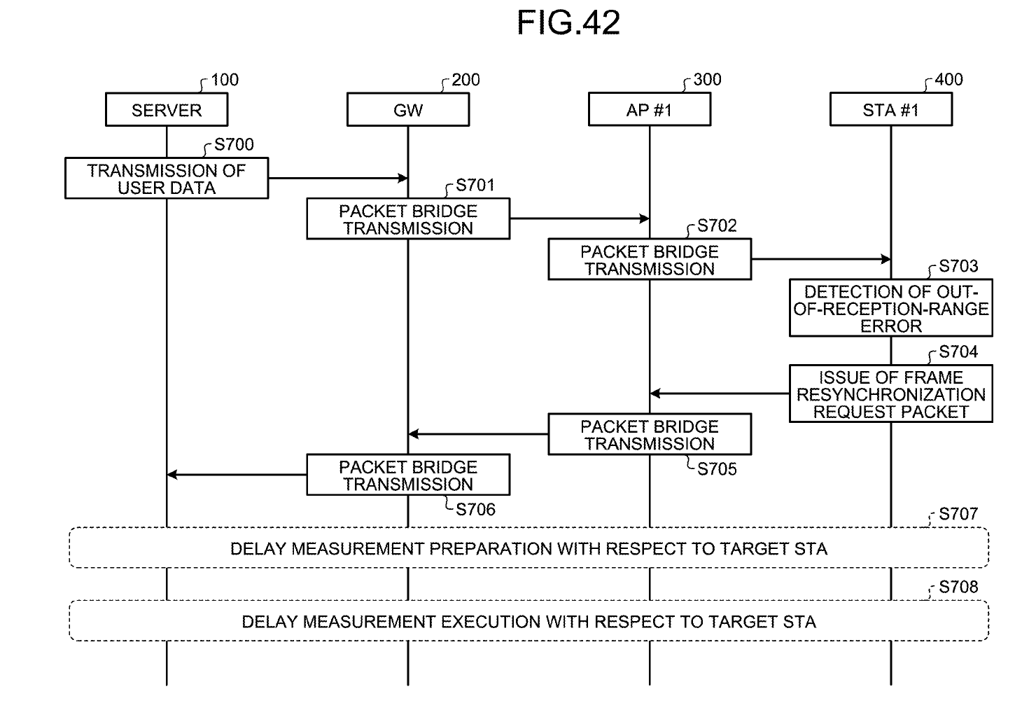

FIG. 42 is a sequence diagram illustrating an example of a solution 2 with respect to the issues arising in the wireless communication system according to the fifth embodiment. With reference to FIG. 42, the explanation is given about the case in which the STA identified as “STA #1” does not normally receive the packets (data) from the specified slot.

For example, in the time periods of the TDD type, the server 100 sends user data (hereinafter, referred to as a user data packet) (Step S700).

The GW 200 performs packet bridge transmission with respect to the user data packet sent from the server 100. That is, the GW 200 receives the user data packet sent from the server 100, and then sends the user data packet (Step S701).

The AP 300 identified as “AP #1” and representing the neighboring node to the GW 200 performs packet bridge transmission with respect to the user data packet sent from the GW 200. That is, the AP identified as “AP #1” receives the user data packet sent from the GW 200, and then sends the user data packet (Step S702).

The STA 400 identified as “STA #1” and representing the neighboring node to the AP 300 identified as “AP #1” monitors whether or not the user data packet sent from the AP 300 identified as “AP #1” is normally receivable from the specified slot. Herein, if the user data packet is not normally received from the specified slot, the STA 400 identified as “STA #1” detects an out-of-reception-range error (Step S703).

If an out-of-reception-range error is detected, the STA 400 identified as STA #1 issues a frame resynchronization request packet as a resynchronization request mentioned earlier, and sends the frame resynchronization request packet (Step S704).

The AP 300 identified as “AP #1” and representing the neighboring node to the STA 400 identified as “STA #1” performs packet bridge transmission with respect to the frame resynchronization request packet sent from the STA 400 identified as “STA #1”. That is, the AP 300 identified as “AP #1” receives the frame resynchronization request packet sent from the STA 400 identified as “STA #1”, and then sends the frame resynchronization request packet (Step S705).

The GW 200 representing the neighboring node to the AP 300 identified as “AP #1” performs packet bridge transmission with respect to the frame resynchronization request packet sent from the AP 300 identified as “AP #1”. That is, the GW 200 receives the frame resynchronization request packet sent from the AP 300 identified as “AP #1”, and then sends the frame resynchronization request packet to the server 100 (Step S706).

The server 100 receives the frame resynchronization request packet sent from the GW 200. At that time, in the time periods of the TDD type, delay measurement preparation is performed with respect to the target STA (in this case, the STA 400 illustrated as “STA #1”) (Step S707). Then, in the time periods of the CSMA type specified in the delay measurement preparation, delay measurement execution is performed with respect to the target STA (the STA 400 identified as “STA #1”) (Step S708). Herein, delay measurement preparation (Step S707) is equivalent to “delay measurement preparation” illustrated in FIG. 32, and delay measurement execution (Step S708) is equivalent to “delay measurement execution” illustrated in FIG. 32.

Effect

As described above, in the wireless communication system according to the fifth embodiment, the following effect can be achieved because of the solution 1-1, the solution 1-2, and the solution 2 with respect to the issues.

Firstly, in the solution 1-1, the notification information processing unit of each of a plurality of wireless communication devices obtains the starting position “SLOT #0” of the frame “FRAME #n” in the free-running clock 30 and obtains the starting position “SLOT #0” of the frame at the time of receiving beacon information. Then, the notification information processing unit detects the time difference Δt_{FRAME} between the starting position “SLOT #0” of the frame “FRAME #n” in the free-running clock 30 and the starting position “SLOT #0” of the frame at the time of receiving beacon information. If the time difference Δt_{FRAME} is equal to or greater than a threshold value, then the notification information processing unit issues a resynchronization request to the server 100.

In the solution 1-1, for example, if the GW 200 represents the wireless communication device, then the notification processing unit includes the analog processing layer 210, the media processing layer 220, the OS/driver layer 230, and the application layer 240. Alternatively, for example, if the AP 300 represents the wireless communication device, then the notification information processing unit includes the analog processing layer 310, the media processing layer 320, the OS/driver layer 330, and the application layer 340. Still alternatively, for example, if the STA 400 represents the wireless communication device, then the notification information processing unit includes the analog processing layer 410, the media processing layer 420, the OS/driver layer 430, and the application layer 440. For example, with reference to FIG. 39, the STA 400 identified as “STA #1” represents the wireless communication device and, when the detected time difference Δt_{FRAME} is equal to or greater than the threshold value, the notification information processing unit issues a resynchronization request to the server 100.

In response to the resynchronization request, the server 100 sends delay measurement information as a resynchronization instruction. Using the delay measurement information, the wireless communication devices present in the delay measurement path P41 (in this case, the GW 200, the AP 300 identified as “AP #1”, and the STA 400 identified as “STA #1”) are specified; and delay measurement and delay adjustment is performed. Based on the delay measurement and the delay adjustment, each wireless communication device present in the delay measurement path P41 (i.e., the GW 200, the AP 300 identified as “AP #1”, and the STA 400 identified as “STA #1”) synchronizes the corresponding frame “FRAME #n” in the free-running clock 30 to the frame at the time of receiving beacon information.

In this way, because of the solution 1-1 with respect to the issues arising in the wireless communication system according to the fifth embodiment, delay adjustment can be performed on a periodic basis without having to frequently perform delay adjustment in the time periods of the CSMA type.

In the solution 1-2, the notification information processing unit of each of a plurality of wireless communication devices obtains the starting position “SLOT #0” of the frame “FRAME #n” in the free-running clock 30 and obtains the starting position “SLOT #0” of the frame at the time of receiving beacon information. Then, the notification information processing unit detects the time difference Δt_{FRAME} between the starting position “SLOT #0” of the frame “FRAME #n” in the free-running clock 30 and the starting position “SLOT #0” of the frame at the time of receiving beacon information. If the time difference Δt_{FRAME} is equal to or greater than a threshold value, then the notification information processing unit adjusts the slot length of the starting position “SLOT #0” of the frame “FRAME #n” in the free-running clock 30 based on the time difference Δt_{FRAME}. With that, the notification information processing unit synchronizes the corresponding frame “FRAME #n” in the free-running clock 30 to the frame at the time of receiving beacon information.

In the solution 1-2, for example, if the GW 200 represents the wireless communication device, then the notification processing unit includes the analog processing layer 210, the media processing layer 220, the OS/driver layer 230, and the application layer 240. Alternatively, for example, if the AP 300 represents the wireless communication device, then the notification information processing unit includes the analog processing layer 310, the media processing layer 320, the OS/driver layer 330, and the application layer 340. Still alternatively, for example, if the STA 400 represents the wireless communication device, then the notification information processing unit includes the analog processing layer 410, the media processing layer 420, the OS/driver layer 430, and the application layer 440. For example, with reference to FIG. 41, the STA 400 identified as “STA #1” represents the wireless communication device and, when the detected time difference Δt_{FRAME} is equal to or greater than the threshold value, the notification information processing unit autonomously performs frame resynchronization based on the time difference Δt_{FRAME}.

In this way, because of the solution 1-2 with respect to the issues arising in the wireless communication system according to the fifth embodiment, delay adjustment can be performed on a periodic basis without having to frequently perform delay adjustment in the time periods of the CSMA type.

In the solution 2, firstly, if the data is not normally received from the specified slot, then the notification information processing unit of each of a plurality of wireless communication devices issues a resynchronization request to the server 100.

In the solution 2, for example, if the GW 200 represents the wireless communication device, then the notification processing unit includes the analog processing layer 210, the media processing layer 220, the OS/driver layer 230, and the application layer 240. Alternatively, for example, if the AP 300 represents the wireless communication device, then the notification information processing unit includes the analog processing layer 310, the media processing layer 320, the OS/driver layer 330, and the application layer 340. Still alternatively, for example, if the STA 400 represents the wireless communication device, then the notification information processing unit includes the analog processing layer 410, the media processing layer 420, the OS/driver layer 430, and the application layer 440. For example, with reference to FIG. 42, the STA 400 identified as “STA #1” represents the wireless communication device and, when the data is not normally received from the specified slot, the notification information processing unit issues a resynchronization request to the server 100.

In response to the resynchronization request, the server 100 sends delay measurement information as a resynchronization instruction. Using the delay measurement information, the wireless communication devices present in the delay measurement path P41 (in this case, the GW 200, the AP 300 identified as “AP #1”, and the STA 400 identified as “STA #1”) are specified; and delay measurement and delay adjustment is performed. Based on the delay measurement and the delay adjustment, each wireless communication device present in the delay measurement path P41 (i.e., the GW 200, the AP 300 identified as “AP #1”, and the STA 400 identified as “STA #1”) synchronizes the corresponding frame “FRAME #n” in the free-running clock 30 to the frame at the time of receiving beacon information.

In this way, because of the solution 2 with respect to the issues arising in the wireless communication system according to the fifth embodiment, delay adjustment can be performed on a periodic basis without having to frequently perform delay adjustment in the time periods of the CSMA type.

### Other Embodiments

Meanwhile, in the first to fifth embodiments described above, the constituent elements of the devices illustrated in the drawings are merely conceptual, and need not be physically configured as illustrated. That is, the specific configurations of the constituent elements are not limited to the illustrated configurations and the constituent elements, as a whole or in part, can be separated or integrated either functionally or physically based on various types of loads or use condition.

Moreover, the various operations performed in the devices can be entirely or partially implemented in a central processing unit (CPU) (or in microcomputer such as a micro processing unit (MPU)) or a micro controller unit (MCU). Alternatively, the various operations can be entirely or partially implemented in computer programs analyzed and executed in a CPU (or a microcomputer such as an MPU or an MCU), or can be entirely or partially implemented using hardware such as wired logic.

The server 100, the GW 200, the APs 300, and the STAs 400 according to the first to fifth embodiments can be implemented using, for example, a hardware configuration as described below.

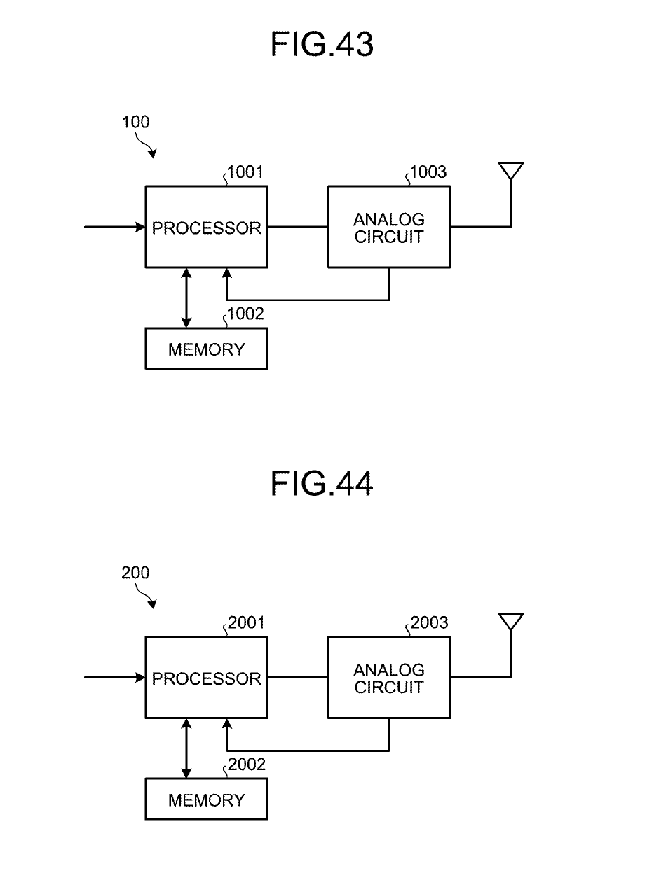

FIG. 43 is a diagram illustrating an exemplary hardware configuration of the server 100. As illustrated in FIG. 43, the server 100 includes a processor 1001, a memory 1002, and an analog circuit 1003. Examples of the processor 1001 include a CPU, a digital signal processor (DSP), and a field programmable gate array (FPGA). Examples of the memory 1002 include a random access memory (RAM) such as a synchronous dynamic random access memory (SDRAM); a read only memory (ROM); and a flash memory.

The various operations performed in the server 100 according to the first to fifth embodiments can be implemented by making a processor execute computer programs stored in various memories such as nonvolatile memory media. For example, computer programs corresponding to the operations performed in the media processing layer 110, the application layer 120, and the database layer 130 can be recorded in the memory 1002, and the processor 1001 can execute those computer programs.

Herein, although it is assumed that the various operations performed in the server 100 according to the first to fifth embodiments are implemented by a single processor 1001, that is not the only possible case. Alternatively, the various operations can be implemented using a plurality of processors.

FIG. 44 is a diagram illustrating an exemplary hardware configuration of the GW 200. As illustrated in FIG. 44, the GW 200 includes a processor 2001, a memory 2002, and an analog circuit 2003. Examples of the processor 2001 include a CPU, a DSP, and an FPGA. Examples of the memory 2002 include a RAM such as an SDRAM; a ROM; and a flash memory.

The various operations performed in the GW 200 according to the first to fifth embodiments can be implemented by making a processor execute computer programs stored in various memories such as nonvolatile memory media. For example, computer programs corresponding to the operations performed in the media processing layer 220, the OS/driver layer 230, and the application layer 240 can be recorded in the memory 2002; and the processor 2001 can execute those computer programs. Meanwhile, the analog processing layer 210 of the GW 200 illustrated in FIG. 5 is implemented using the analog circuit 2003.

Herein, although it is assumed that the various operations performed in the GW 200 according to the first to fifth embodiments are implemented by a single processor 2001, that is not the only possible case. Alternatively, the various operations can be implemented using a plurality of processors.

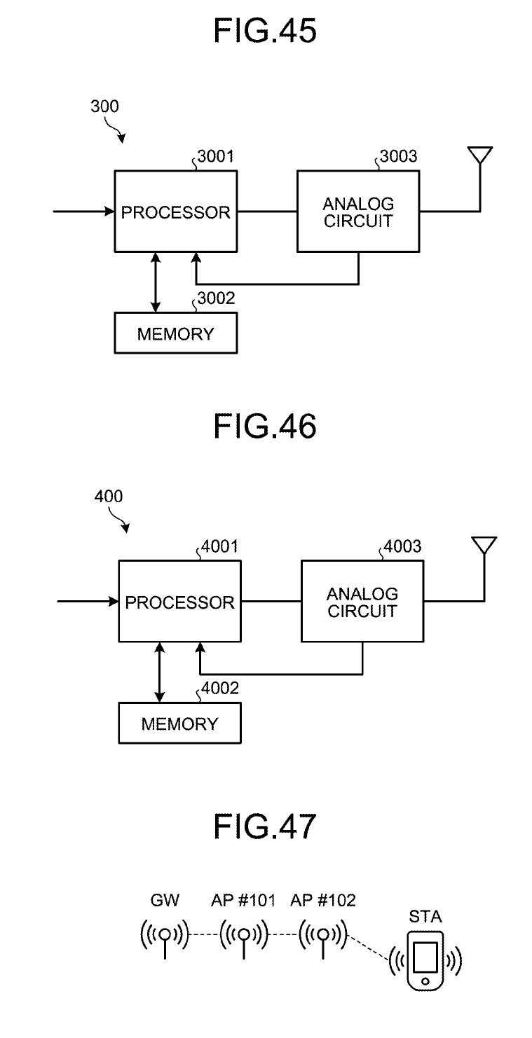

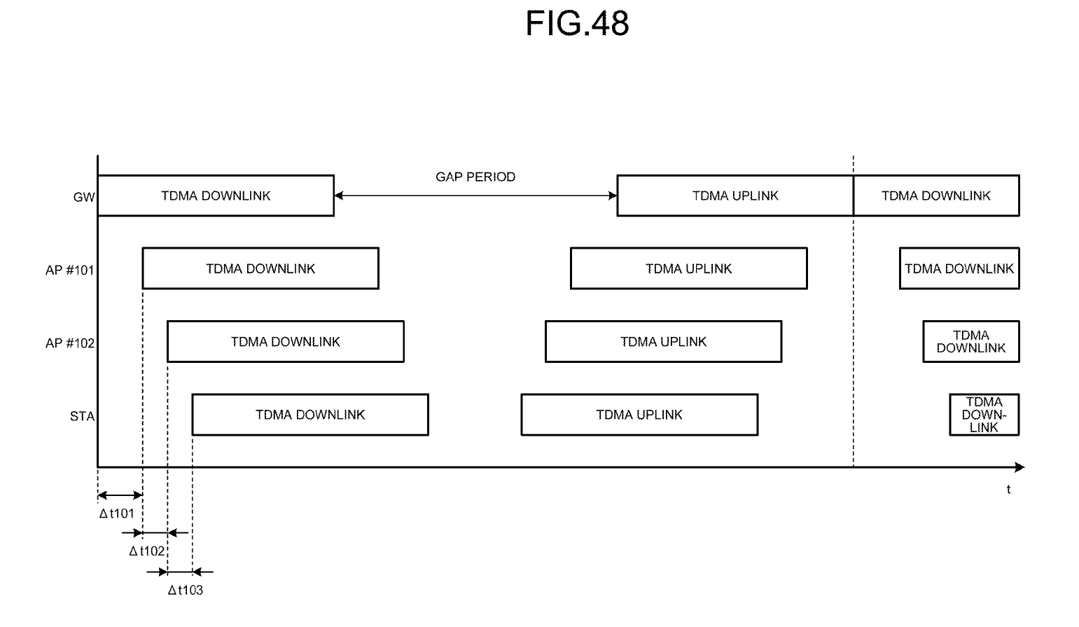

FIG. 45 is a diagram illustrating an exemplary hardware configuration of the AP 300. As illustrated in FIG. 45, the AP 300 includes a processor 3001, a memory 3002, and an analog circuit 3003. Examples of the processor 3001 include a CPU, DSP, and an FPGA. Examples of the memory 3002 include a RAM such as an SDRAM; a ROM; and a flash memory.

The various operations performed in the AP 300 according to the first to fifth embodiments can be implemented by making a processor execute computer programs stored in various memories such as nonvolatile memory media. For example, computer programs corresponding to the operations performed in the media processing layer 320, the OS/driver layer 330, and the application layer 340 can be recorded in the memory 3002; and the processor 3001 can execute those computer programs. Meanwhile, the analog processing layer 310 of the AP 300 illustrated in FIG. 6 is implemented using the analog circuit 3003.

Herein, although it is assumed that the various operations performed in the AP 300 according to the first to fifth embodiments are implemented by a single processor 3001, that is not the only possible case. Alternatively, the various operations can be implemented using a plurality of processors.

FIG. 46 is a diagram illustrating an exemplary hardware configuration of the STA 400. As illustrated in FIG. 46, the STA 400 includes a processor 4001, a memory 4002, and an analog circuit 4003. Examples of the processor 4001 include a CPU, DSP, and an FPGA. Examples of the memory 4002 include a RAM such as an SDRAM; a ROM; and a flash memory.

The various operations performed in the STA 400 according to the first to fifth embodiments can be implemented by making a processor execute computer programs stored in various memories such as nonvolatile memory media. For example, computer programs corresponding to the operations performed in the media processing layer 420, the OS/driver layer 430, and the application layer 440 can be recorded in the memory 4002; and the processor 4001 can execute those computer programs. Meanwhile, the analog processing layer 410 of the STA 400 illustrated in FIG. 7 is implemented using the analog circuit 4003.

Herein, although it is assumed that the various operations performed in the STA 400 according to the first to fifth embodiments are implemented by a single processor 4001, that is not the only possible case. Alternatively, the various operations can be implemented using a plurality of processors.

As an aspect, the gap periods can be used in an effective manner.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication system comprising:
a server that sends notification information in which starting position of a frame is specified; and
a plurality of wireless communication devices representing nodes assigned to the server, wherein
each of the plurality of wireless communication devices includes
a notification information processing unit that receives the notification information, and
a communication processing unit that, according to the notification information, performs communication of time division duplex (TDD) type, and performs communication of carrier sense multiple access (CSMA) type during a period of time between a downlink time period and an uplink time period of the TDD type.

2. The wireless communication system according to claim 1, wherein
the notification information is assigned to a first slot among a plurality of slots assigned to a single frame, and
in a plurality of paths in which the notification information is transferred, the notification information processing unit of the plurality of wireless communication devices assigns the notification information to a slot, among the plurality of slots, that is present at position corresponding to a node hop count indicating number of nodes which the notification information has passed through.

3. The wireless communication system according to claim 2, wherein the notification information processing unit of the plurality of wireless communication devices
assigns, in a first path among the plurality of paths in which the node hop count is identical, the notification information to a slot, among the plurality of slots, that is present at position corresponding to the node hop count, and
copies the notification information in other paths other than the first path among the plurality of paths in which the node hop count is identical, and assigns the copied notification information to a slot, among the plurality of slots, that is present at position specified by the server.

4. The wireless communication system according to claim 1, wherein
the server sends delay measurement information that contains a delay measurement path from a first wireless communication device to a second wireless communication device among the plurality of wireless communication devices,
the notification information processing unit of each wireless communication device present in the delay measurement path transfers a packet in the time period of the CSMA type based on the delay measurement information,
the notification information processing unit of the first wireless communication device performs delay measurement meant for measuring delay period between transmission of the packet and reception of the packet in the delay measurement path,
the notification information processing unit of the second wireless communication device performs delay adjustment, which is meant for adjusting time of sending data of the TDD type, based on the delay period notified from the first wireless communication device, and
when the delay measurement and the delay adjustment is being performed, based on the delay measurement information, the communication processing unit of each wireless communication device not present in the delay measurement path stops communication of the CSMA type with wireless communication devices present in the delay measurement path.

5. The wireless communication system according to claim 4, wherein
when time difference between starting position of frame in a free-running clock and starting position of frame at time of receiving the notification information is equal to or greater than a threshold value, the notification information processing unit of the plurality of wireless communication devices issues a resynchronization request to the server,
in response to the resynchronization request, the server sends the delay measurement information as a resynchronization instruction, and
based on the delay measurement and the delay adjustment performed using the delay measurement information, the notification information processing unit of each wireless communication device present in the delay measurement path specified in the delay measurement information synchronizes frame in the free-running clock to frame at time of receiving the notification information.

6. The wireless communication system according to claim 4, wherein
when data is not normally receivable from a specified slot, the notification information processing unit of the plurality of wireless communication devices issues a resynchronization request to the server,
in response to the resynchronization request, the server sends the delay measurement information as a resynchronization instruction, and
based on the delay measurement and the delay adjustment, the notification information processing unit of each wireless communication device present in the delay measurement path specified in the delay measurement information synchronizes frame in the free-running clock to frame at time of receiving the notification information.

7. The wireless communication system according to claim 1, wherein, when time difference between starting position of frame in free-running clock and starting position of frame at time of receiving notification information is equal to or greater than a threshold value, the notification information processing unit of the plurality of wireless communication devices synchronizes frame in the free-running clock to frame at time of receiving the notification information by adjusting slot length of starting position of frame in the free-running clock based on the time difference.

8. A wireless communication device that represents a node assigned to a server which sends notification information meant for specifying starting position of frame, the wireless communication device comprising:
a notification information processing unit that receives notification information; and
a communication processing unit that, according to the notification information, performs communication of time division duplex (TDD) type, and performs communication of carrier sense multiple access (CSMA) type during a period of time between a downlink time period and an uplink time period of the TDD type.

9. A communication method in which a plurality of wireless communication devices representing nodes assigned to a server which sends notification information meant for specifying starting position of frame, the communication method comprising:
receiving the notification information;
performing, according to the notification information, communication of time division duplex (TDD) type; and
performing communication of carrier sense multiple access (CSMA) type during a period of time between a downlink time period and an uplink time period of the TDD type.
